(19) United States
(12) Patent Application Publication
(10) Pub. No.: US 2024/0305349 A1
(43) Pub. Date: Sep. 12, 2024

(54) BEAMFORMED RELAY OPERATIONS IN WIRELESS NETWORKS

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR)

(73) Assignee: NEWRACOM, Inc., Irvine, CA (US)

(21) Appl. No.: 18/597,805

(22) Filed: Mar. 6, 2024

Related U.S. Application Data
(60) Provisional application No. 63/488,961, filed on Mar. 7, 2023.

(51) Int. Cl. H04B 7/06; H04W 16/28

(52) U.S. Cl. CPC H04B 7/06952; H04W 16/28

(57) ABSTRACT

Disclosed herein is a method performed by a transmitter station (STA) to perform beam alignment with a receiver STA. The method includes wirelessly transmitting a first plurality of beam-sweeping frames in a first plurality of beam directions, wirelessly receiving a second plurality of beam-sweeping frames from the receiver STA, wherein the second plurality of beam-sweeping frames were transmitted by the receiver STA in a second plurality of beam directions, determining which of the first plurality of beam directions is considered to be the best transmitter beam direction, selecting one of the second plurality of beam directions to be a best receiver beam direction, wirelessly transmitting a best beam indication feedback (BBF) frame to the receiver STA in the best transmitter beam direction, wherein the BBF frame indicates the best receiver beam direction, and wirelessly receiving a BBF acknowledgement (ACK) frame that acknowledges the BBF frame from the receiver STA.

### CROSS-REFERENCE TO RELATED APPLICATION

This application claims the benefit of U.S. Provisional Application No. 63/488,961, filed Mar. 7, 2023, titled, “Beamformed Relay Operation for Beyond IEEE 802.11be,” which is hereby incorporated by reference.

### TECHNICAL FIELD

The present disclosure generally relates to wireless communications, and more specifically, relates to a beamformed relay in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

Due to the scarcity of available bandwidth in below-7 GHz frequency channels, millimeter wave (mmWave) frequency channels (above 7 GHz (e.g., serval tens of GHz)) are being considered for use in future wireless standards (e.g., beyond IEEE 802.11be). However, while mm Wave channels have wider bandwidth compared to below-7 GHz channels, they have more severe path loss, which limits their communication range.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing an environment in which beamformed relay operations may be performed, according to some embodiments.

FIG. 9 is a diagram showing a transmitter STA transmitting beam-sweeping frames to a receiver STA, according to some embodiments.

FIG. 10 is a diagram showing a receiver STA transmitting beam-sweeping frames with feedback information to the transmitter STA, according to some embodiments.

FIG. 11 is a diagram showing the transmitter STA transmitting a frame that includes feedback information indicating the best receiver beam direction and the receiver STA transmitting a corresponding acknowledgement frame, according to some embodiments.

FIG. 12 is a diagram showing a two-stage beam alignment procedure and downlink transmission using a beamformed relay in an operating scenario where both below-7 GHZ and mmWave channels are used, according to some embodiments.

FIG. 13 is a diagram showing a two-stage beam alignment procedure and uplink transmission using a beamformed relay in an operating scenario where both below-7 GHZ and mmWave channels are used, according to some embodiments.

FIG. 14 is a diagram showing a two-stage beam alignment procedure in an operating scenario where only a mmWave channel is used, according to some embodiments.

FIG. 15 is a diagram showing another two-stage beam-alignment procedure in an operating scenario where only a mmWave channel is used, according to some embodiments.

FIG. 16 is a flow diagram showing a method performed by a transmitter STA for performing beam alignment with a receiver STA, according to some embodiments.

FIG. 17 is a flow diagram showing a method performed by a receiver STA for performing beam alignment with a transmitter STA, according to some embodiments.

FIG. 18 is a flow diagram showing a method performed by an AP for performing beam alignment with a relay STA that is to relay frames between the AP and a non-relay STA, according to some embodiments.

FIG. 19 is a flow diagram showing a method performed by a relay STA for performing beam alignment with an AP and a non-relay STA to allow the relay STA to relay frames between the AP and the non-relay STA, according to some embodiments.

FIG. 20 is a flow diagram showing a method performed by a non-relay STA for performing beam alignment with a relay STA that is to relay frames between an AP and the non-relay STA, according to some embodiments.

FIG. 21 is a flow diagram showing a method performed by an AP for performing beam alignment (based on sectored beacons) with a relay STA that is to relay frames between the AP and a non-relay STA, according to some embodiments.

FIG. 22 is a flow diagram showing a method performed by a relay STA for performing beam alignment (based on sectored beacons) with an AP and a non-relay STA to allow the relay STA to relay frames between the AP and the non-relay STA, according to some embodiments.

FIG. 23 is a flow diagram showing a method performed by a relay STA for performing beam alignment (based on relayed beacons) with an AP and a non-relay STA to allow the relay STA to relay frames between the AP and the non-relay STA, according to some embodiments.

FIG. 24 is a flow diagram showing a method performed by a non-relay STA for performing beam alignment (based on relayed beacons) with a relay STA that is to relay frames between an AP and the non-relay STA, according to some embodiments.

### DETAILED DESCRIPTION

One aspect of the present disclosure generally relates to wireless communications, and more specifically, relates to a beamformed relay in a wireless network.

Embodiments are disclosed herein that can extend the communication range in a wireless network using a beamformed relay technique. A beamformed relay may involve an access point (AP), a relay station (STA), and a non-relay STA.

According to some embodiments, the AP may transmit a beamformed data frame including data intended for the non-relay STA to the relay STA. Upon receiving the beamformed data frame from the AP, the relay STA may transmit a beamformed relay data frame that includes the data intended for the non-relay STA to the non-relay STA. The combination of beamforming and relay helps extend the communication range in the wireless network (e.g., the AP is able to reach STAs that are beyond its normal coverage area).

To achieve communication range extension with a beamformed relay, proper beam alignment is needed. Performing beam alignment for a beamformed relay may include two stages. The first stage is performing beam alignment between the AP and the relay STA. The second stage is performing beam alignment between the relay STA and the non-relay STA. In an embodiment, beam alignment is performed as follows. The AP may transmit a plurality of beam-sweeping frames in a first plurality of beam directions. The relay STA may receive the plurality of beam-sweeping frames from the AP. The relay STA may select one of the first plurality of beam directions that is associated with the highest received power level to be a best AP beam direction. The relay STA may then transmit a second plurality of beam-sweeping frames in a second plurality of beam directions. Each of the second plurality of beam-sweeping frames may include a first indication of the best AP beam direction as determined by the relay STA. The AP may receive the second plurality of beam-sweeping frames from the relay STA. The AP may determine which of the first plurality of beam directions is considered to be the best AP beam direction based on the first indication included in one of the second plurality of beam-sweeping frames. The AP may select one of the second plurality of beam directions that is associated with a highest received power level at the AP to be a best relay STA beam direction. The AP may then transmit a best beam indication feedback (BBF) frame to the relay STA in the best AP beam direction. The BBF frame may include a second indication of the best relay STA beam direction as determined by the AP. The relay STA may determine which of the second plurality of beam directions is considered to be the best relay STA beam direction facing the AP based on the second indication included in the BBF frame. The relay STA may transmit a BBF acknowledgement (ACK) frame that acknowledges the BBF frame to the AP. The non-relay STA may also receive the second plurality of beam-sweeping frames from the relay STA. The non-relay STA may select one of the second plurality of beam directions that is associated with a highest received power level at the non-relay STA to be a best relay STA beam direction. The non-relay STA may then transmit a third plurality of beam-sweeping frames in a third plurality of beam directions. Each of the third plurality of beam-sweeping frames may include a third indication of the best relay STA beam direction as determined by the non-relay STA. The relay STA may receive the third plurality of beam-sweeping frames from the non-relay STA. The relay STA may determine which of the third plurality of beam directions is considered to be the best relay STA beam direction facing the non-relay STA based on the third indication included in one of the third plurality of beam-sweeping frames. The relay STA may select one of the third plurality of beam directions that is associated with a highest received power level at the relay STA to be a best non-relay STA beam direction. The relay STA may then transmit a BBF frame to the non-relay STA in the best relay STA beam direction facing the non-relay STA. The BBF frame may include a fourth indication of the best non-relay STA beam direction as determined by the relay STA. The non-relay STA may determine which of the third plurality of beam directions is considered to be the best non-relay STA beam direction based on the fourth indication included in the BBF frame. The non-relay STA may transmit a BBF ACK frame that acknowledges the BBF frame to the non-relay STA. This completes the beam alignment procedure.

Once the beam alignment procedure is complete, the AP may transmit a data frame that includes data intended for the non-relay STA to the relay STA in the best AP beam direction. The relay STA may then transmit a relay data frame that includes the data intended for the non-relay STA to the non-relay STA in the best relay STA beam direction facing the non-relay STA. Upon successfully receiving the relay data frame from the relay STA, the non-relay STA may transmit an ACK frame that acknowledges the relay data frame to the relay STA in the best non-relay STA beam direction. The relay STA may then transmit a relay ACK frame that acknowledges the data frame to the AP in the best relay STA beam direction facing the AP. In this way, the AP may transmit data to the non-relay STA via the relay STA. In a similar manner, the non-relay STA may transmit data to the AP via the relay STA. The use of beamforming and relay allows the communication range in the wireless network to be extended.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

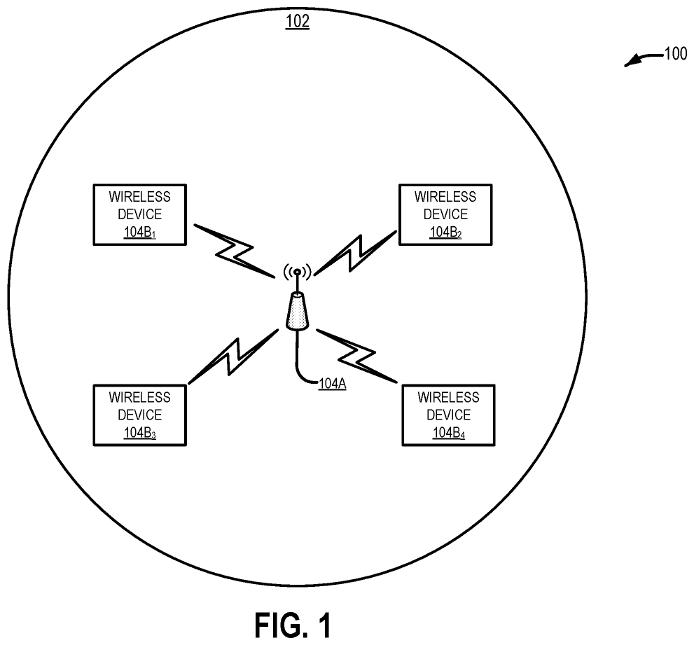

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/bc). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for case of description, only the non-AP STAs may be referred to as STAs. Although shown with four non-AP STAs (e.g., the wireless devices 104B1-104B4), the WLAN 100 may include any number of non-AP STAs (e.g., one or more wireless devices 104B).

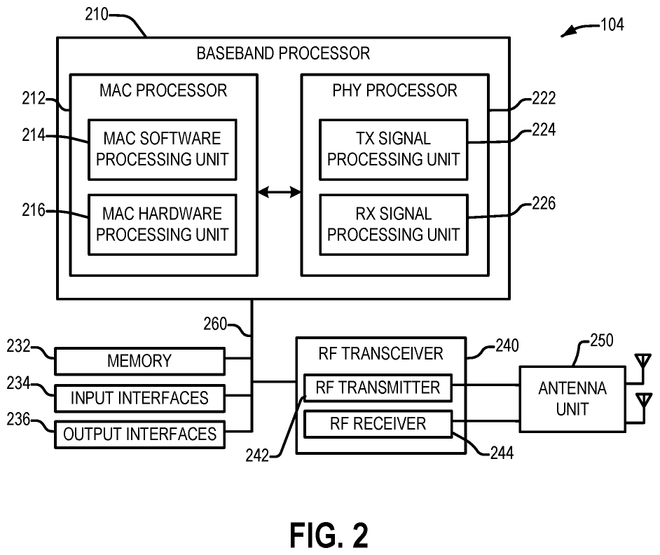

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

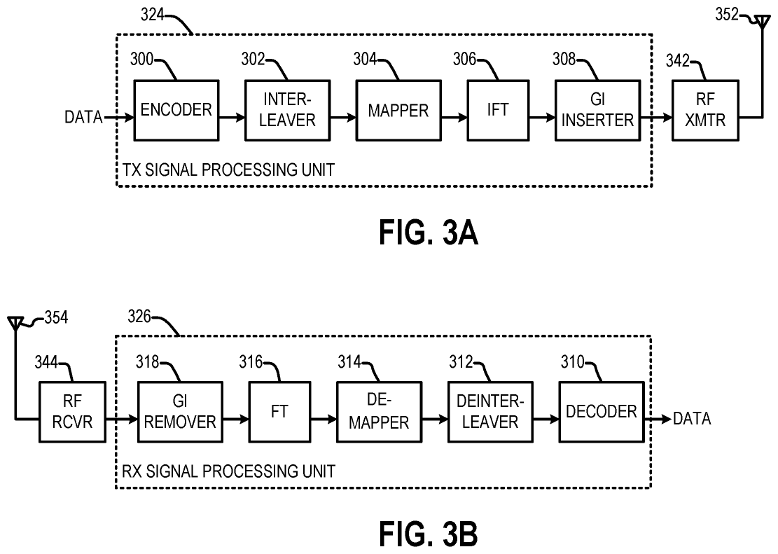

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or Is. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MH2, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

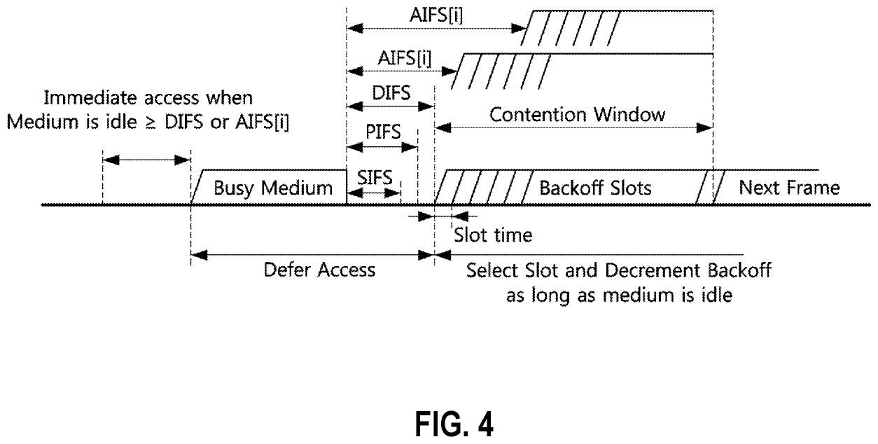

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

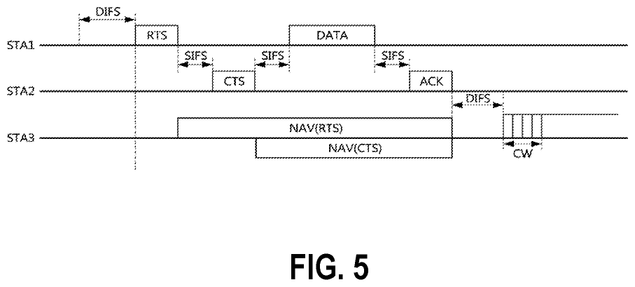

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 docs not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

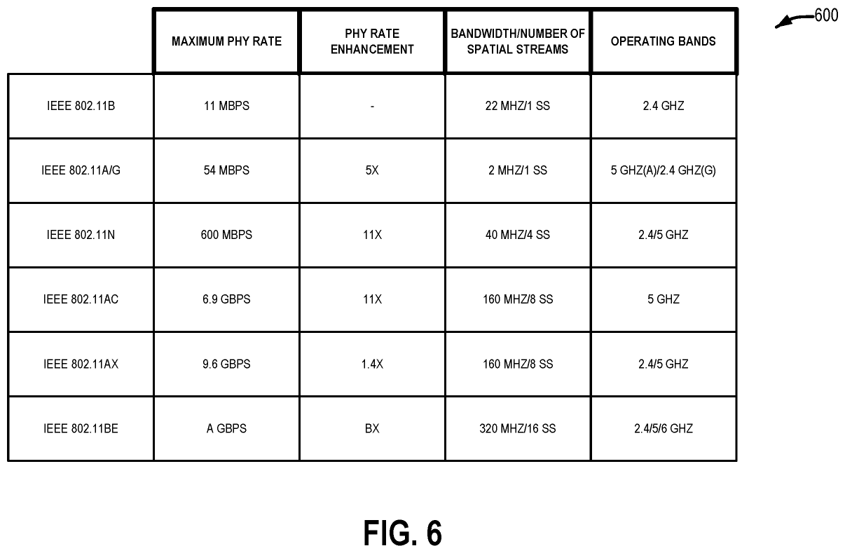

With clear demand for higher peak throughput/capacity in a WLAN, a new working group has been assembled to generate an amendment to IEEE 802.11. This amendment is called IEEE 802.11be (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, arc solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHZ) could be considered to increase the maximum PHY rate. For example, 320 MHz or 160+160 MHz data could be transmitted in the 6 GHz band. For example, 160+160 MHz data could be transmitted across the 5 and 6 GHz bands.

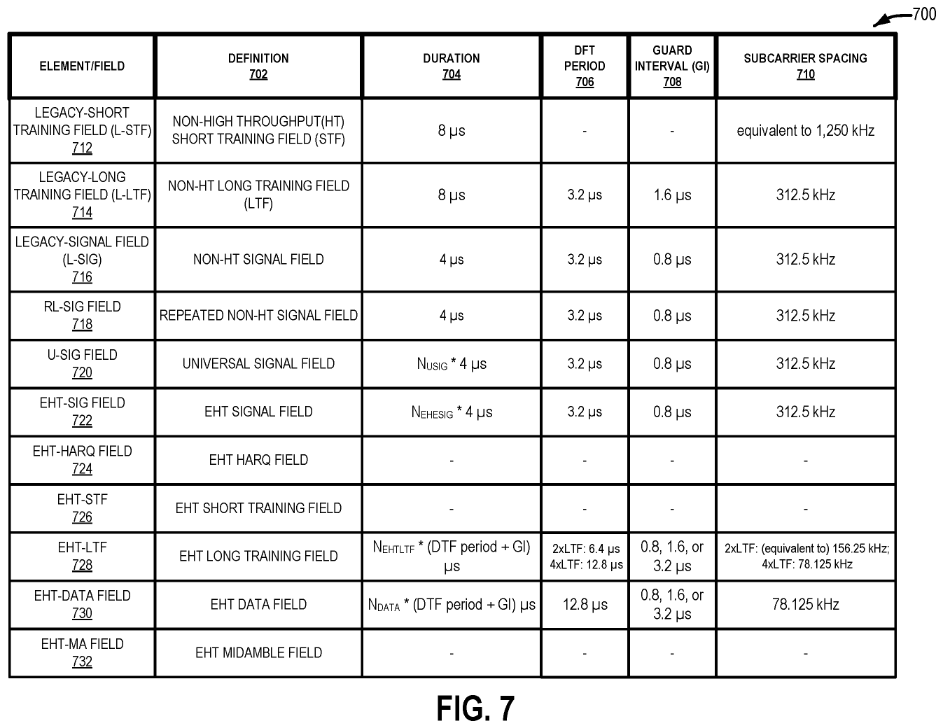

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink(UL)/downlink(DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HAPQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

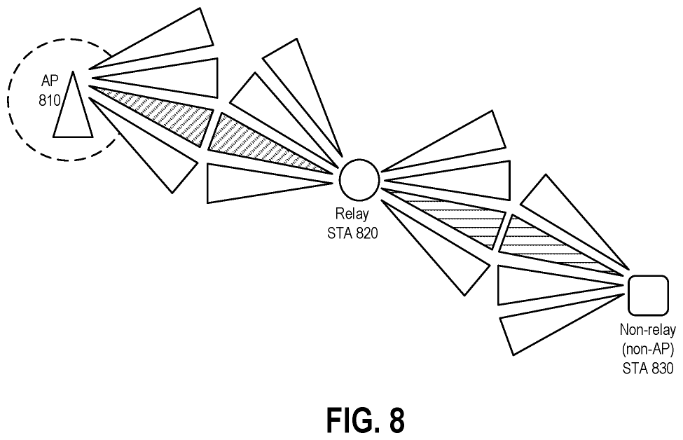

FIG. 8 is a diagram showing an environment in which beamformed relay operations may be performed, according to some embodiments.

As shown in the diagram, the environment includes an AP 810, a relay STA 820, and a non-relay STA 830. The AP 810, the relay STA 820, and the non-relay STA 830 may have beamforming capability, and thus be able to (wirelessly) transmit signals in different beam directions. The relay STA 820 may relay data between the AP 810 and the non-relay STA 830. As will be described in additional detail herein, the AP 810, relay STA 820, and non-relay STA 830 may use a beamformed relay technique to extend the communication range in the wireless network. Due to the scarcity of available bandwidth in below-7 GHz frequency channels, millimeter wave (mmWave) frequency channels (above 7 GHz (e.g., serval tens of GHz)) are being considered for usage in future wireless standards (e.g., beyond IEEE 802.11bc). Since mm Wave channels have much higher pathloss compared to below-7 GHz channels, it is even more important to be able to extend the communication range in wireless networks (e.g., Wi-Fi networks) that use mmWave channels.

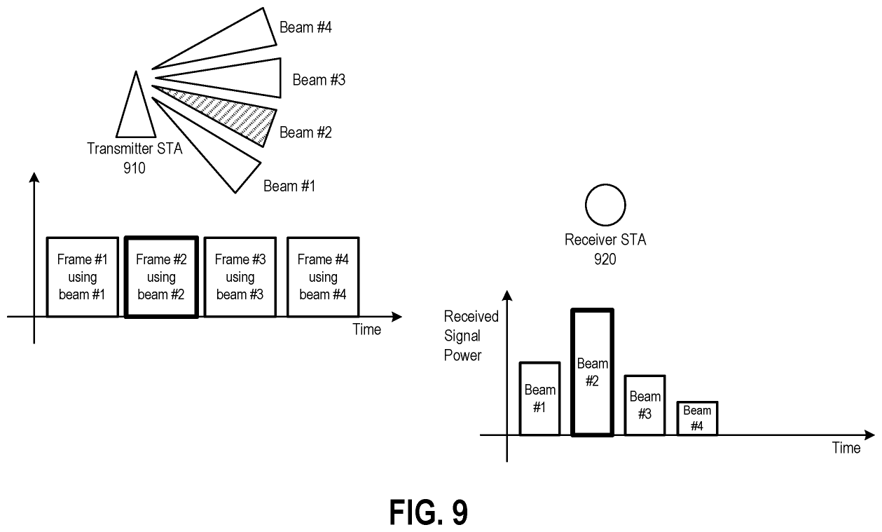

To maximize the communication range in the wireless network, a beam alignment procedure may be needed to determine the best beam directions between the AP and the relay STA 820, as well as the best beam directions between the relay STA 820 and the non-relay STA. For example, as shown in the diagram, the shaded beams correspond to the best beam directions. Communication range can be maximized by using these aligned beam directions for signal transmission and reception. In an embodiment, a beam alignment procedure is used to determine the best beam directions. The beam alignment procedure may involve a first beam alignment procedure between the AP 810 and the relay STA 820 and a second beam alignment procedure between the relay STA 820 and the non-relay STA 830. FIGS. 9, 10, and 11 are diagrams showing a frame exchange sequence for a beam alignment procedure between a transmitter STA and a receiver STA.

FIG. 9 is a diagram showing a transmitter STA transmitting beam-sweeping frames to a receiver STA, according to some embodiments.

A transmitter STA 910 may transmit multiple frames in multiple beam directions. Such frames may be referred to herein as beam-sweeping frames. For example, as shown in the diagram, the transmitter STA 910 may transmit frame #1 in beam direction #1, transmit frame #2 in beam direction #2, transmit frame #3 in beam direction #3, and transmit frame #4 in beam direction #4. The receiver STA 920 may receive the frames with different received power levels. For example, as shown in the diagram, the receiver STA 920 may receive frame #2 with the highest received power level, frame #1 with the next highest received power level, frame #3 with the next highest received power level, and frame #4 with the lowest received power level. The receiver STA 920 may designate the beam direction associated with the frame having the highest received power level (at the receiver STA 920) as being the best beam direction at the transmitter STA side (also referred to as the best transmitter beam direction). In this example, the receiver STA 920 designates beam direction #2 as being the best transmitter beam direction since it is associated with the frame having the highest received power level. After determining the best transmitter beam direction, the receiver STA 920 may perform similar beam-sweeping operations as the transmitter STA 910 to determine the best beam direction at the receiver STA side.

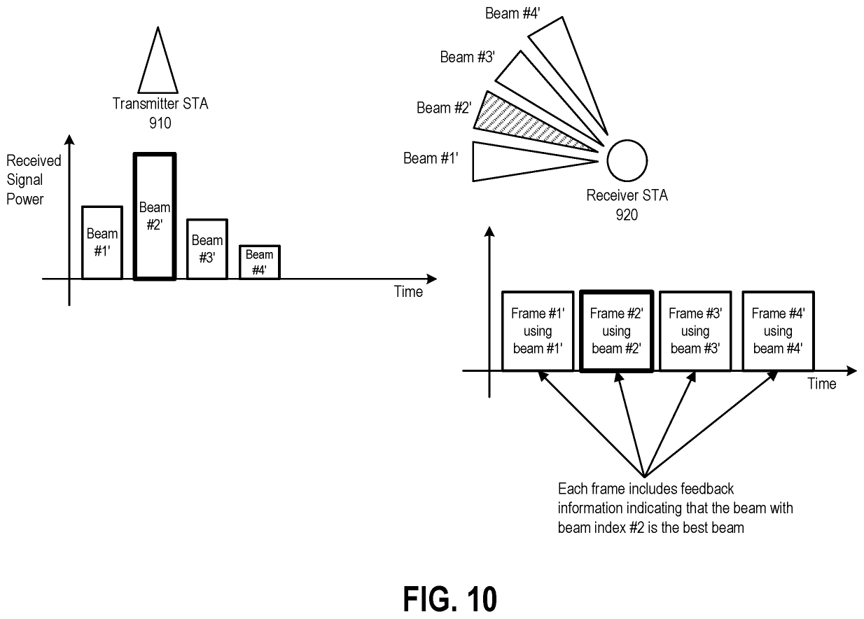

FIG. 10 is a diagram showing a receiver STA transmitting beam-sweeping frames with feedback information to the transmitter STA, according to some embodiments.

The receiver STA 920 may transmit multiple frames in multiple beam directions. For example, as shown in the diagram, the receiver STA 920 may transmit frame #1′ in beam direction #1′, transmit frame #2′ in beam direction #2′, transmit frame #3′ in beam direction #3′, and transmit frame #4′ in beam direction #4′. The difference between these frames and the frames transmitted by the transmitter STA 910 is that these frames include feedback information indicating the best transmitter beam direction. In this example, the receiver STA 920 determined that beam direction #2 is the best transmitter beam direction. As such, each of the frames transmitted by the receiver STA 920 may include feedback information indicating that beam direction #2 is the best transmitter beam direction. The transmitter STA 910 may determine that beam direction #2 is the best transmitter beam direction based on the feedback information included in one of the frames transmitted by the receiver STA 920. The transmitter STA 910 may receive the frames from the receiver STA 920 with different received power levels. For example, as shown in the diagram, the transmitter STA 910 may receive frame #2′ with the highest received power level, frame #1′ with the next highest received power level, frame #3′ with the next highest received power level, and frame #4′ with the lowest received power level. The transmitter STA 910 may designate the beam direction associated with the frame having the highest received power level (at the transmitter STA 910) as being the best beam direction at the receiver STA side (also referred to as the best receiver beam direction). In this example, the transmitter STA 910 designates beam direction #2′ as being the best receiver beam direction since it is associated with the frame having the highest received power level.

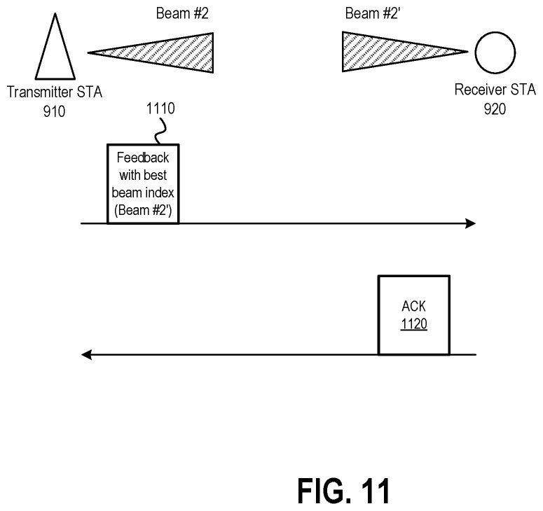

FIG. 11 is a diagram showing the transmitter STA transmitting a frame that includes feedback information indicating the best receiver beam direction and the receiver STA transmitting a corresponding acknowledgement frame, according to some embodiments.

After determining the best receiver beam direction, as described above, the transmitter STA 910 may transmit a feedback frame 1110 that includes an indication of the best receiver beam direction, as determined by the transmitter STA 910 (e.g., beam direction #2′), to the receiver STA 920. In an embodiment, the indication of the best beam direction is expressed as a beam index (e.g., beam index #2′) in the feedback frame 1110. The receiver STA 920 may then transmit an ACK frame 1120 that acknowledges the feedback frame 1110 to the transmitter STA 910 if the receiver STA 920 receives the feedback frame 1110 without error. Based on such a frame exchange sequence, the transmitter STA 910 and the receiver STA 920 may determine the best beam directions to reach each other, and the beam alignment is complete.

The beam alignment procedure described above is for aligning beams between the transmitter STA 910 and the receiver STA 920. For a beamformed relay, a two-stage beam alignment procedure may be used. The two-stage beam alignment procedure may include a first beam alignment procedure between an AP and a relay STA and a second beam alignment procedure between the relay STA and a non-relay STA.

Two different operating scenarios are considered in the examples provided herein. The first operating scenario is a scenario in which both mmWave and below-7 GHz channels are used. In the first operating scenario, due to bandwidth limitations, control frames such as beacon frame may be transmitted using below-7 GHz channels, while data frames may be transmitted using mm Wave channels. In an embodiment, some control frames (e.g., BBF frames, BBF ACK frames, ACK frames, and relay ACK (R-ACK) frames) may be beamformed in mmWave channels. For example, if beam alignment is complete and the control frame does not need to be broadcasted, the control frame may be beamformed in mm Wave channels. The second scenario is a scenario where only mmWave channels are used.

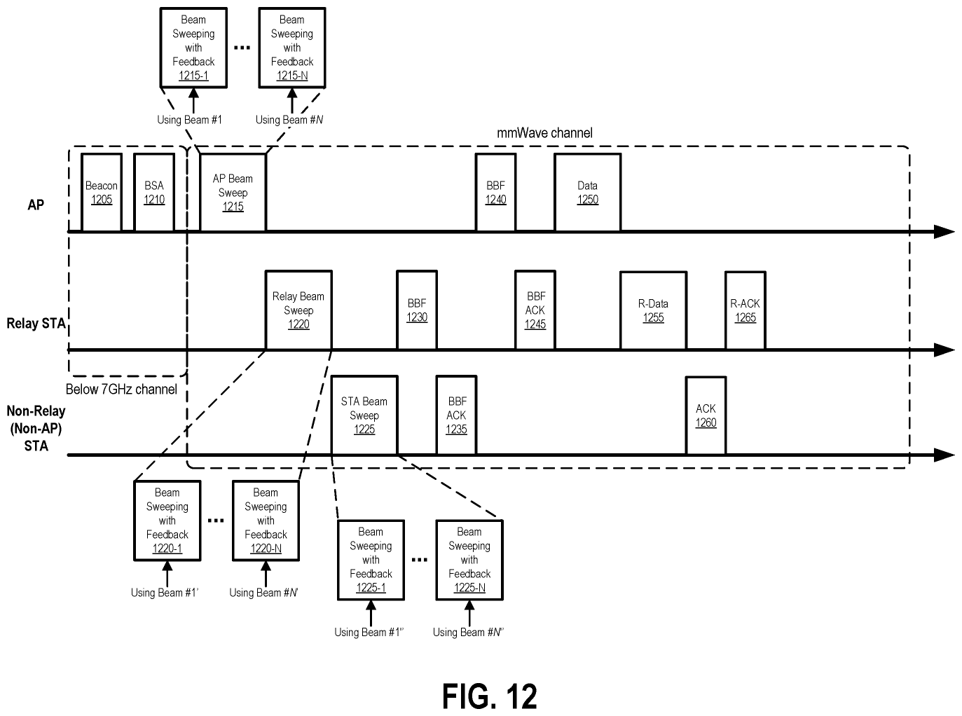

FIG. 12 is a diagram showing a two-stage beam alignment procedure and downlink transmission using a beamformed relay in an operating scenario where both below-7 GHz and mmWave channels are used, according to some embodiments.

In the first operating scenario with both below-7 GHz and mmWave channels, control frames (e.g., beacon frame) may be transmitted using a below-7 GHz channel since the below 7 GHz channel generally has a longer communication range (compared to mmWave channels) given the same transmit power.

As shown in the diagram, the AP transmits a beacon frame 1205 followed by a beam-sweeping announcement (BSA) frame 1210 to initiate the beam alignment procedure. The AP may transmit the beacon frame 1205 and the BSA frame 120 using a below-7 GHz channel. The BSA frame 1210 may include the IDs of the relay STA and the ID of the non-relay STA. In an embodiment, the BSA frame 120 includes information regarding the number of beam-sweeping frames that the AP will transmit and information regarding the transmission scheme that the AP will use. After transmitting the BSA frame 1210, the AP may sequentially transmit multiple beam-sweeping frames 1215 in multiple beam directions. For example, as shown in the diagram, the AP may transmit beam-sweeping frames 1215-1 to 1215-N in beam directions #1 to #N, respectively. In another embodiment, the AP may simultaneously transmit the beam-sweeping frames 1215 using different subchannels to reduce the beam-sweeping duration and/or improve network efficiency.

After receiving the beam-sweeping frames 1215 from the AP, the relay STA may select one of the beam directions used by the AP that is associated with the highest received power level at the relay STA to be the best AP beam direction. The relay STA may then transmit multiple beam-sweeping frames 1220 in multiple beam directions. For example, as shown in the diagram, the relay STA may transmit beam-sweeping frames 1220-1 to 1220-N in beam directions #1′ to #N′, respectively. Each of the beam-sweeping frames 1220 transmitted by the relay STA may include feedback information regarding the best AP beam direction as determined by the relay STA. As will be described in additional detail herein, the relay beam-sweeping frames 1220 transmitted by the relay STA are used for providing information regarding the best AP beam direction (for the link between the AP and the relay STA) to the AP, as well as to allow the non-relay STA to determine the best relay STA beam direction (for the link between the relay STA and the non-relay STA). Thus, the relay beam-sweeping frames 1220 may be used for two purposes: the first purpose is for providing information regarding the best AP beam direction to the AP and the second purpose is for allowing the non-relay STA to determine the best relay STA beam direction.

After receiving the beam-sweeping frame 1220 from the relay STA, the non-relay STA may select one of the beam directions used by the relay STA that is associated with the highest received power level at the non-relay STA to be the best relay STA beam direction facing the non-relay STA. The non-relay STA may then transmit multiple beam-sweeping frames 1225 in multiple beam directions. For example, as shown in the diagram, the non-relay STA may transmit beam-sweeping frames 1225-1 to 1225-N in beam directions #1″ to #N″, respectively. Each of the beam-sweeping frames 1225 transmitted by the non-relay STA may include feedback information regarding the best relay STA beam direction as determined by the non-relay STA.

After receiving the beam-sweeping frames 1225 from the non-relay STA, the relay STA may select one of the beam directions used by the non-relay STA that is associated with the highest received power level at the relay STA to be the best non-relay STA beam direction. The relay STA may then transmit a best beam indication feedback (BBF) frame 1230 to the non-relay STA. The BBF frame 1230 may include feedback information regarding the best non-relay STA beam direction as determined by the relay STA. For example, the best beam direction may be indicated in the BBF frame 1230 using an index corresponding to the beam with the best beam direction. The non-relay STA may then transmit a corresponding BBF ACK frame 1235 that acknowledges the BBF frame 1230 to the relay STA if the non-relay STA receives the BBF frame 1230 without error. In an embodiment, the relay STA transmits the BBF frame 1230 multiple times until it receives a BBF ACK frame 1235 from the non-relay STA (e.g., because the non-relay STA may not be able to successfully decode the BBF frame 1230 when the beam direction used by the non-relay STA for reception is not optimal). In another embodiment, the relay STA transmits multiple BBF frames 1230 sequentially without waiting to receive a BBF ACK frame 1235.

Similarly, after receiving the beam-sweeping frames 1220 from the relay STA, the AP may select one of the beam directions used by the relay STA that is associated with the highest received power level at the AP to be the best non-relay STA beam direction facing the AP. The AP may then transmit a BBF frame 1240 to the relay STA. The BBF frame 1240 may include feedback information regarding the best relay STA beam direction as determined by the AP. The relay STA may then transmit a corresponding BBF ACK frame 1245 that acknowledges the BBF frame 1240 to the AP if the relay STA receives the BBF frame 1240 without error. Thus, there are two BBF frame and BBF ACK frame exchanges in this sequence (one between the relay STA and the non-relay STA and one between the AP and the relay STA). While the example shown in the diagram shows the BBF frame and BBF ACK frame exchange between the relay STA and the non-relay STA occurring before the BBF frame and BBF ACK frame exchange between the AP and the relay STA, in some embodiments, the order may be switched. This completes the beam alignment procedure.

Once the beam alignment procedure is complete, the AP and the non-relay AP may exchange data using a beamformed relay. As shown in the diagram, for downlink transmission (e.g., from the AP to the non-relay STA via the relay STA), the AP may transmit a data frame 1250 that includes data intended for the non-relay STA to the relay STA. The relay STA may decode the data frame 1250 to obtain the data intended for the non-relay STA and transmit a relay data frame 1255 (R-data) that includes the data intended for the non-relay STA to the non-relay STA. The non-relay STA may decode relay data frame 1255 to obtain the data intended for the non-relay STA and transmit an ACK frame 1260 to the relay STA if it decodes the relay data frame 1255 without error. Responsive to receiving the ACK frame 1260 from the non-relay STA, the relay STA may transmit a relay ACK frame 1265 (R-ACK) to the AP.

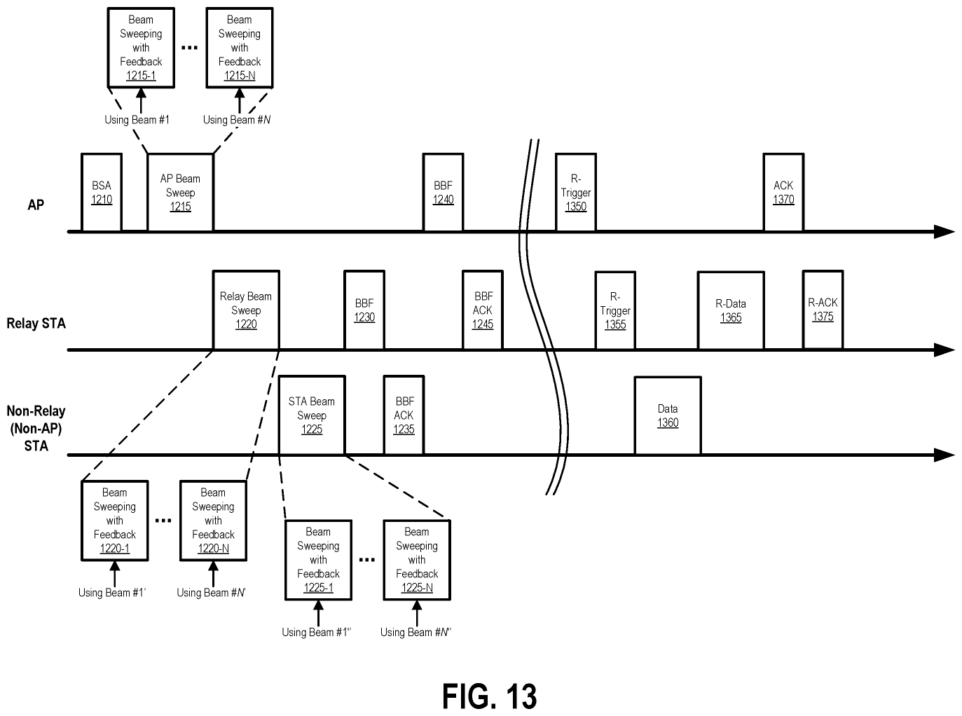

FIG. 13 is a diagram showing a two-stage beam alignment procedure and uplink transmission using a beamformed relay in an operating scenario where both below-7 GHz and mmWave channels are used, according to some embodiments.

As shown in the diagram, the AP, relay STA, and non-relay STA may perform a two-stage beam alignment procedure by exchanging frames 1210-1245, as described above with reference to FIG. 12. A description of the two-stage beam alignment procedure is not repeated here for sake of brevity.

As shown in the diagram, for uplink transmission (e.g., from the non-relay STA to the AP via the relay STA), the AP may transmit a relay trigger frame 1350 (R-Trigger) to the relay STA. Responsive to receiving the relay trigger frame 1350 from the AP, the relay STA may then transmit a relay trigger frame 1355 to the non-relay STA. After receiving the relay trigger frame 1355 from the relay STA, the non-relay STA may transmit a data frame 1360 that includes data intended for the AP to the relay STA. The relay STA may decode the data frame 1360 to obtain the data intended for the AP and transmit a relay data frame 1365 (R-Data) that includes the data intended for the AP to the AP. The AP may decode the relay data frame 1365 to obtain the data intended for the AP and transmit an ACK frame 1370 to the relay STA if it decodes the relay data frame 1365 without error. Responsive to receiving the ACK frame 1370 from the AP, the relay STA may transmit a relay ACK frame 1375 (R-ACK) to the non-relay STA. In an embodiment, the relay trigger frames 1350 and 1355 may be omitted and the uplink transmission can be initiated after the exchange of the BBF frames (frames 1230 and 1240) and the BBF ACK frames (frames 1235 and 1245).

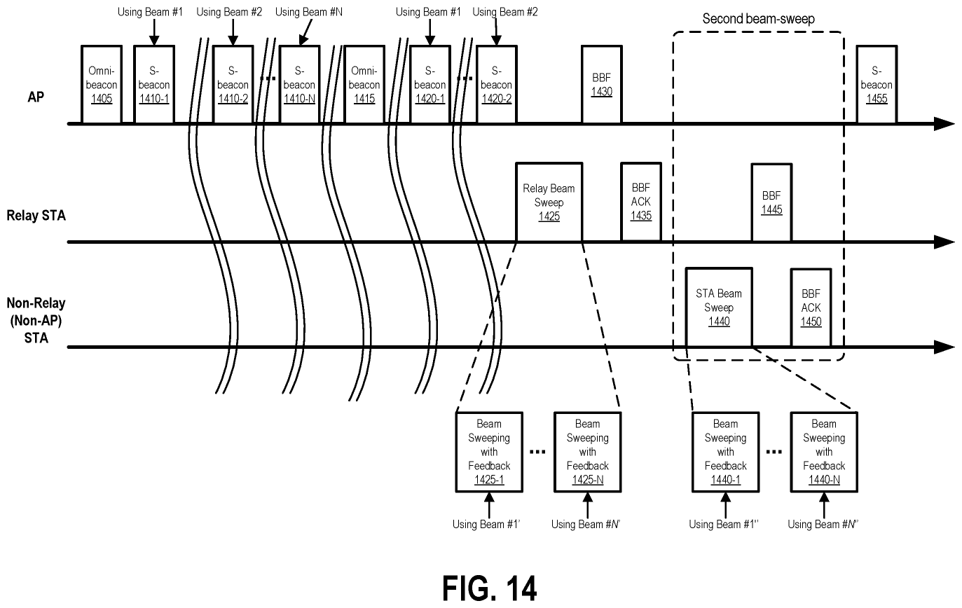

FIG. 14 is a diagram showing a two-stage beam alignment procedure in an operating scenario where only a mmWave channel is used, according to some embodiments.

In the second operating scenario with only mm Wave channels, all frames may be transmitted using a mmWave channel. In this case, two types of beacon frames may be used: (1) an omnidirectional beacon frame; and (2) a sectored beacon frame (which may be a beamformed (or directed) beacon frame). An AP may transmit multiple sectored beacon frames in multiple different beam directions between two omnidirectional beacon frames. The interval between omnidirectional beacon frames may be referred to as an omnidirectional beacon interval.

For example, as shown in the diagram, the AP may transmit an omnidirectional beacon frame 1405 (Omni-beacon) followed by multiple sectored beacon frames 1410-1 to 1410-N(S-beacon). The sectored beacon frames 1410-1 to 1410-N may be transmitted in beam directions #1 to #N, respectively. The relay STA may receive the sectored beacon frames 1410 and select one of the beam directions used by the AP that is associated with the highest received power level at the relay STA to be the best AP beam direction. In this example, it is assumed that the relay STA determines that beam direction #2 is the best AP beam direction.

After transmitting the sectored beacon frames 1410, the AP may transmit an omnidirectional beacon frame 1415 to start the next omnidirectional beacon interval. The AP may then transmit sectored beacon frames 1420-1 and 1420-2 in beam directions #1 and #2, respectively. The relay STA may then transmit beam-sweeping frames 1425 in multiple beam directions to perform a relay beam-sweep. For example, the relay STA may transmit beam-sweeping frames 1425-1 to 1425-N in beam directions #1′ to #N′, respectively. Each of the beam-sweeping frames 1425 may include feedback information regarding the best AP beam direction, as determined by the relay STA. After the relay beam-sweep, the AP may transmit a BBF frame 1430 to the relay STA (that includes feedback information regarding the best relay STA beam direction, as determined by the AP) and the relay STA may transmit a corresponding BBF ACK frame 1435 to the AP to complete the beam alignment procedure between the AP and the relay STA.

The non-relay STA may then transmit multiple beam-sweeping frames 1440 in multiple beam directions to perform a STA beam-sweep. For example, the non-relay STA may transmit beam-sweeping frames 1440-1 to 1440-N in beam directions #1″ to #N″, respectively. Each of the beam-sweeping frames 1440 may include feedback information regarding the best relay STA beam direction facing the non-relay STA. After the STA beam-sweep, the relay STA may transmit a BBF frame 1445 to the non-relay STA (that includes feedback information regarding the best non-relay STA beam direction) and the non-relay STA may transmit a corresponding BBF ACK frame 1450 to the relay STA to complete the beam alignment procedure between the relay STA and the non-relay STA. In an embodiment, the second beam-sweep (encompassed by the dashed box in FIG. 14) may be performed in a different sectored beacon interval than shown in the diagram (e.g., after sectored beacon frame 1455). As used herein, a sectored beacon interval may refer to the interval between two consecutive sectored beacon frames. The AP may transmit additional sectored beacon frames such as sectored beacon frame 1455.

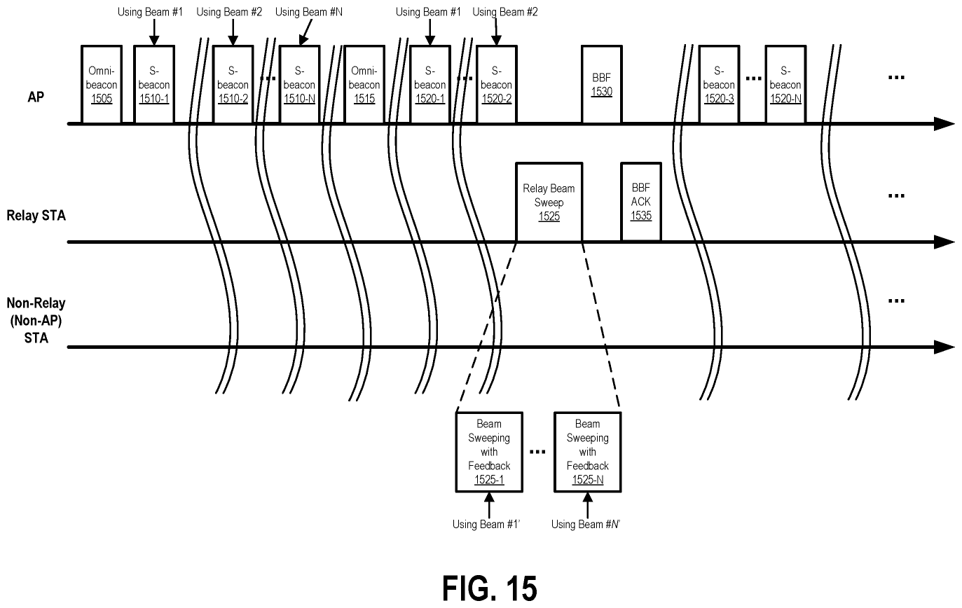

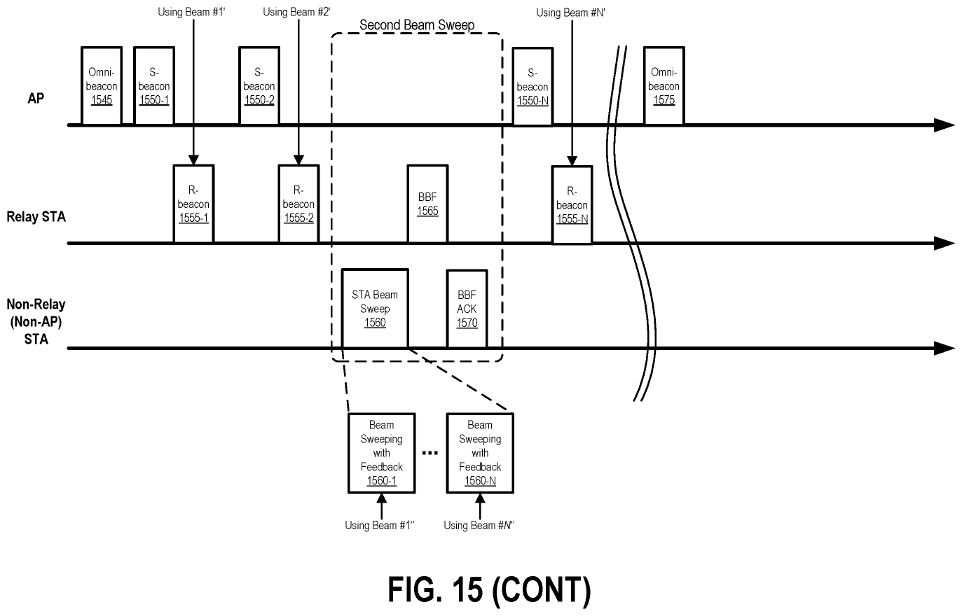

FIG. 15 is a diagram showing another two-stage beam-alignment procedure in an operating scenario where only a mmWave channel is used, according to some embodiments.

In an embodiment, as will be described in additional detail herein below, the concept of a sectored beacon is used at the relay STA. The AP and the relay STA may perform the first stage of the beam-sweeping procedure by exchanging frames 1505, 1510-1 to 15010-N, 1515, 1520-1, 1520-2, 1525-1 to 1525-N, 1530, and 1535 in a manner similar as described above with reference to FIG. 14. The AP may transmit additional sectored beacon frames during the omnidirectional beacon interval such as sectored beacon frames 1520-3 to 1520-N.

Subsequently, the AP may transmit an omnidirectional beacon frame 1545 to start a new omnidirectional beacon interval. The AP may then transmit a sectored beacon frame 1550-1 (S-beacon). Responsive to receiving this sectored beacon frame 1550-1, the relay STA may transmit a relay beacon frame 1555-1 (R-beacon) in beam direction #1′. The AP may then transmit another sectored beacon frame 1550-2. Responsive to receiving this sectored beacon frame 1550-2, the relay STA may transmit a relay beacon frame 1555-2 in beam direction #2′. In this way, the relay STA may transmit multiple relay beacon frames in different beam directions in response to receiving sectored beacon frames from the AP. Since the non-relay STA can determine the best relay STA beam direction during the relay beam-sweep 1525 in the previous omnidirectional beacon interval, the non-relay STA may start the STA beam-sweep 1560 after receiving the relay beacon frame that is transmitted by the relay STA in the best beam direction. For example, the non-relay STA may transmit beam-sweeping frames 1560-1 to 1560-N in beam directions #1″ to #N″, respectively, after receiving the relay beacon frame 1555-2. Each of the beam-sweeping frames 1560 may include feedback information regarding the best relay STA beam direction facing the non-relay STA. After the STA beam-sweep, the relay STA may transmit a BBF frame 1565 to the non-relay STA (that includes feedback information regarding the best non-relay STA beam direction) and the non-relay STA may transmit a corresponding BBF ACK frame 1570 to the relay STA to complete the beam alignment procedure between the relay STA and the non-relay STA. The AP may transmit additional sectored beacon frames and omnidirectional beacon frames such as sectored beacon frame 1550-N and omnidirectional beacon frame 1575 (e.g., according to a predefined cadence). The relay STA may transmit additional relay beacon frames responsive to receiving sectored beacon frames such as relay beacon frame 1555-N(which may be transmitted responsive to the relay STA receiving sectored beacon frame 1550-N).

The beamformed relay technique disclosed herein can be used to extend the communication range in a wireless network (e.g., a Wi-Fi network). For proper communication range extension, proper beam alignment is needed. The beam alignment procedure disclosed herein can be used to efficiently perform beam alignment between the devices involved in the beamformed relay.

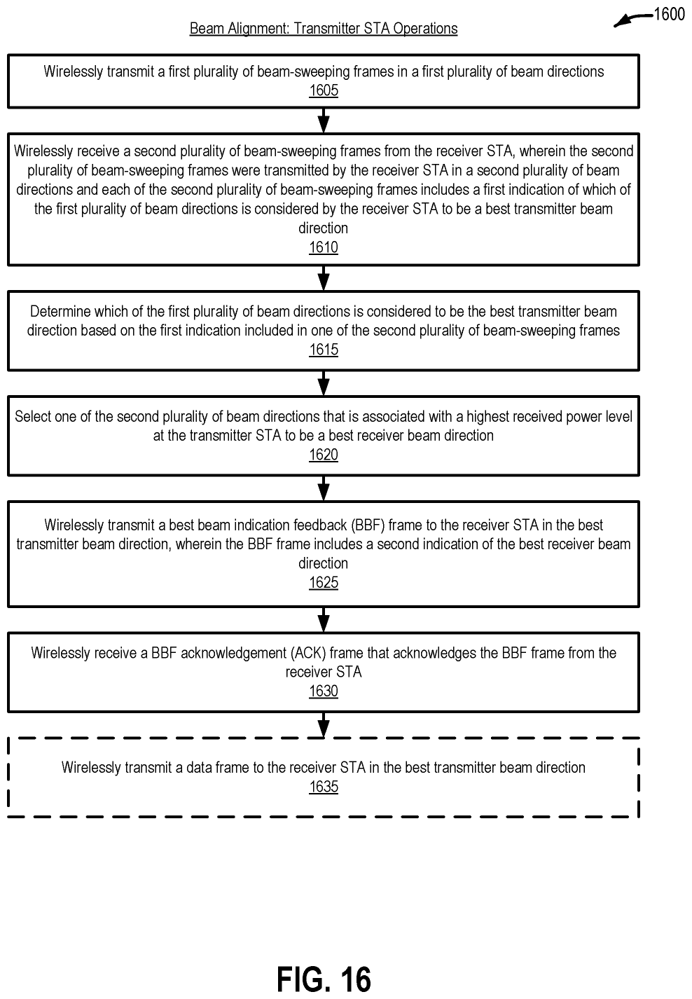

Turning now to FIG. 16, a method 1600 performed by a transmitter STA will be described for performing beam alignment with a receiver STA, in accordance with an example embodiment. The transmitter STA may be implemented by a wireless device 104.

Additionally, although shown in a particular order, in some embodiments the operations of the method 1600 (and the other methods shown in the other figures) may be performed in a different order. For example, although the operations of the method 1600 are shown in a sequential order, some of the operations may be performed in partially or entirely overlapping time periods.

At operation 1605, the transmitter STA wirelessly transmits a first plurality of beam-sweeping frames in a first plurality of beam directions.

At operation 1610, the transmitter STA wirelessly receives a second plurality of beam-sweeping frames from the receiver STA, wherein the second plurality of beam-sweeping frames were transmitted by the receiver STA in a second plurality of beam directions and each of the second plurality of beam-sweeping frames includes a first indication of which of the first plurality of beam directions is considered by the receiver STA to be a best transmitter beam direction.

At operation 1615, the transmitter STA determines which of the first plurality of beam directions is considered to be the best transmitter beam direction based on the first indication included in one of the second plurality of beam-sweeping frames.

At operation 1620, the transmitter STA selects one of the second plurality of beam directions that is associated with a highest received power level at the transmitter STA to be a best receiver beam direction.

At operation 1625, the transmitter STA wirelessly transmits a BBF frame to the receiver STA in the best transmitter beam direction, wherein the BBF frame includes a second indication of the best receiver beam direction.

At operation 1630, the transmitter STA wirelessly receives a BBF ACK frame that acknowledges the BBF frame from the receiver STA.

In an embodiment, at operation 1635, the transmitter STA wirelessly transmits a data frame to the receiver STA in the best transmitter beam direction.

In an embodiment, the transmitter STA is an AP and the receiver STA is a non-AP STA (or vice versa).

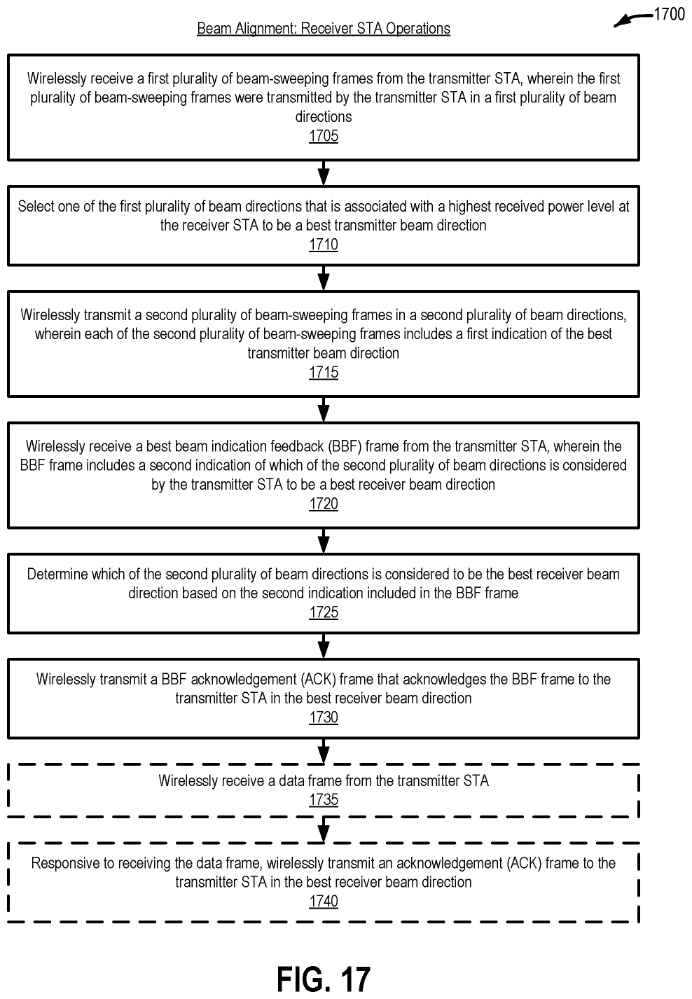

Turning now to FIG. 17, a method 1700 performed by a receiver STA will be described for performing beam alignment with a transmitter STA, in accordance with an example embodiment. The receiver STA may be implemented by a wireless device 104.

At operation 1705, the receiver STA wirelessly receives a first plurality of beam-sweeping frames from the transmitter STA, wherein the first plurality of beam-sweeping frames were transmitted by the transmitter STA in a first plurality of beam directions.

At operation 1710, the receiver STA selects one of the first plurality of beam directions that is associated with a highest received power level at the receiver STA to be a best transmitter beam direction.

At operation 1715, the receiver STA wirelessly transmits a second plurality of beam-sweeping frames in a second plurality of beam directions, wherein each of the second plurality of beam-sweeping frames includes a first indication of the best transmitter beam direction.

At operation 1720, the receiver STA wirelessly receives a BBF frame from the transmitter STA, wherein the BBF frame includes a second indication of which of the second plurality of beam directions is considered by the transmitter STA to be a best receiver beam direction.

At operation 1725, the receiver STA determines which of the second plurality of beam directions is considered to be the best receiver beam direction based on the second indication included in the BBF frame.

At operation 1730, the receiver STA wirelessly transmits a BBF ACK frame that acknowledges the BBF frame to the transmitter STA in the best receiver beam direction.

In an embodiment, at operation 1735, the receiver STA wirelessly receives a data frame from the transmitter STA.

In an embodiment, at operation 1740, responsive to receiving the data frame, the receiver STA wirelessly transmits an ACK frame to the transmitter STA in the best receiver beam direction.

In an embodiment, the receiver STA is a non-AP STA and the transmitter STA is an AP (or vice versa).

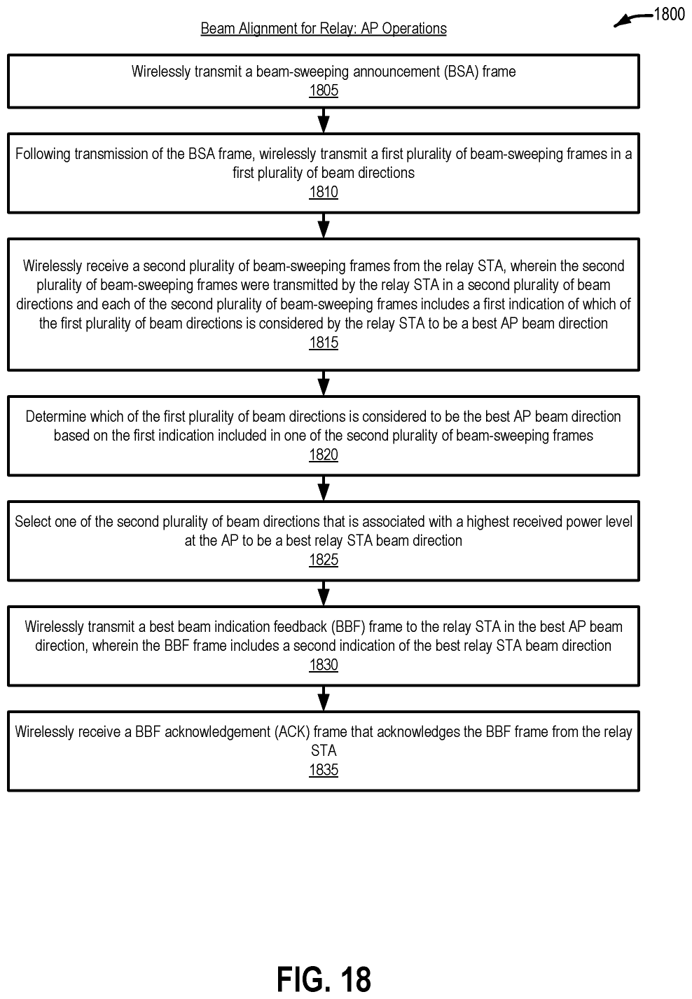

Turning now to FIG. 18, a method 1800 performed by an AP will be described for performing beam alignment with a relay STA that is to relay frames between the AP and a non-relay STA, in accordance with an example embodiment. The AP may be implemented by a wireless device 104.

At operation 1805, the AP wirelessly transmit a BSA frame. In an embodiment, the BSA frame includes an identifier of the relay STA and an identifier of the non-relay STA.

At operation 1810, following transmission of the BSA frame, the AP wirelessly transmits a first plurality of beam-sweeping frames in a first plurality of beam directions. In an embodiment, the first plurality of beam-sweeping frames is transmitted sequentially. In another embodiment, the first plurality of beam-sweeping frames is transmitted simultaneously in different subchannels. In an embodiment, the BSA frame further includes an indication of number of beam-sweeping frames that are to be included in the first plurality of beam-sweeping frames and information regarding a transmission scheme that is to be used to transmit the first plurality of beam-sweeping frames. In an embodiment, the BSA frame is wirelessly transmitted in a below 7 Gigahertz channel and the first plurality of beam-sweeping frames is wirelessly transmitted in a mmWave channel.

At operation 1815, the AP wirelessly receives a second plurality of beam-sweeping frames from the relay STA, wherein the second plurality of beam-sweeping frames were transmitted by the relay STA in a second plurality of beam directions and each of the second plurality of beam-sweeping frames includes a first indication of which of the first plurality of beam directions is considered by the relay STA to be a best AP beam direction.

At operation 1820, the AP determines which of the first plurality of beam directions is considered to be the best AP beam direction based on the first indication included in one of the second plurality of beam-sweeping frames.

At operation 1825, the AP selects one of the second plurality of beam directions that is associated with a highest received power level at the AP to be a best relay STA beam direction.

At operation 1830, the AP wirelessly transmits a BBF frame to the relay STA in the best AP beam direction, wherein the BBF frame includes a second indication of the best relay STA beam direction.

At operation 1835, the AP wirelessly receives a BBF ACK frame that acknowledges the BBF frame from the relay STA.

In an embodiment, the AP wirelessly transmits a data frame that includes data intended for the non-relay STA to the relay STA in the best AP beam direction. The AP may then wirelessly receive a relay ACK frame that acknowledges the data frame from the relay STA.

In an embodiment, the AP wirelessly transmits a relay trigger frame to the relay STA in the best AP beam direction. The AP may then wirelessly receive a relay data frame from the relay STA, wherein the relay data frame includes data intended for the AP that was generated by the non-relay STA.

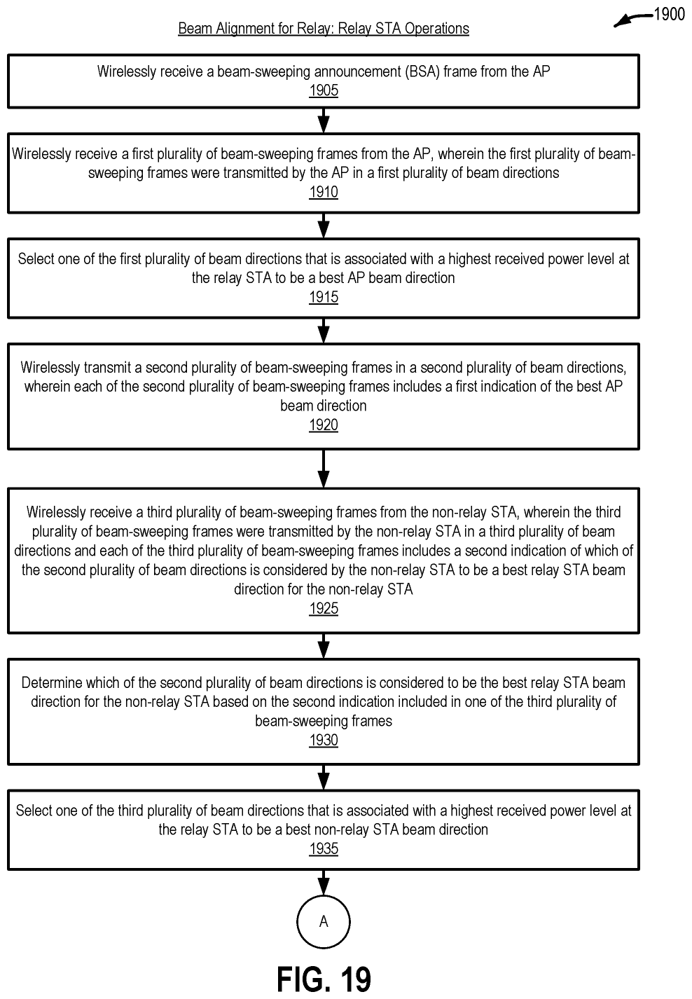

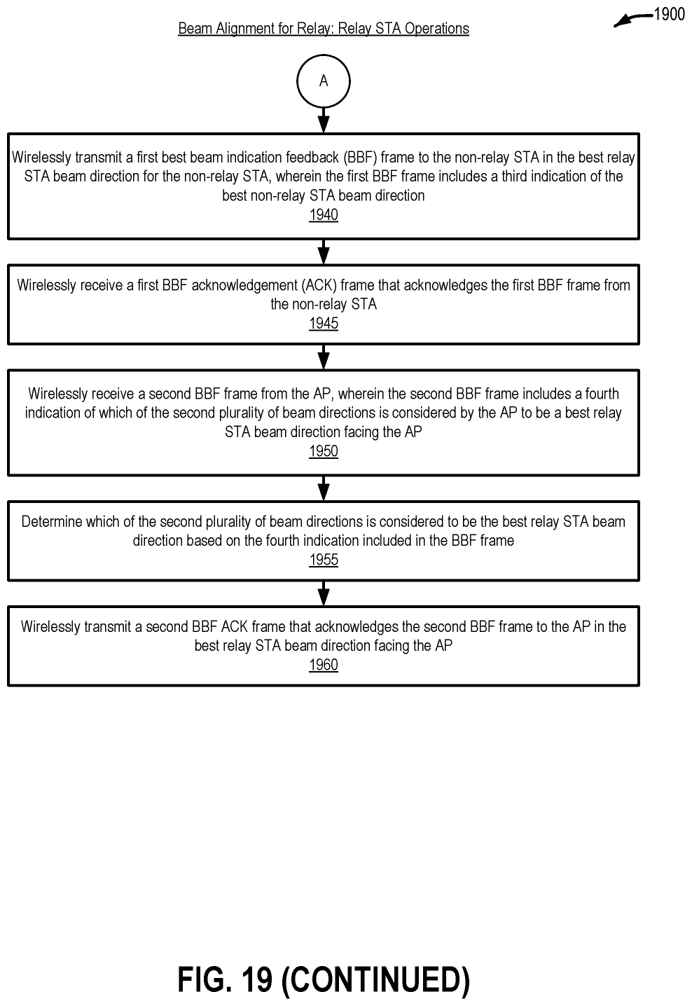

Turning now to FIG. 19, a method 1900 performed by a relay STA will be described for performing beam alignment with an AP and a non-relay STA to allow the relay STA to relay frames between the AP and the non-relay STA, in accordance with an example embodiment. The relay STA may be implemented by a wireless device 104.

At operation 1905, the relay STA wirelessly receives a BSA frame from the AP.

At operation 1910, the relay STA wirelessly receives a first plurality of beam-sweeping frames from the AP, wherein the first plurality of beam-sweeping frames were transmitted by the AP in a first plurality of beam directions.

At operation 1915, the relay STA selects one of the first plurality of beam directions that is associated with a highest received power level at the relay STA to be a best AP beam direction.

At operation 1920, the relay STA wirelessly transmits a second plurality of beam-sweeping frames in a second plurality of beam directions, wherein each of the second plurality of beam-sweeping frames includes a first indication of the best AP beam direction. In an embodiment, the BSA frame is wirelessly transmitted by the AP in a below 7 Gigahertz channel and the second plurality of beam-sweeping frames is wirelessly transmitted in a mmWave channel.

At operation 1925, the relay STA wirelessly receives a third plurality of beam-sweeping frames from the non-relay STA, wherein the third plurality of beam-sweeping frames were transmitted by the non-relay STA in a third plurality of beam directions and each of the third plurality of beam-sweeping frames includes a second indication of which of the second plurality of beam directions is considered by the non-relay STA to be a best relay STA beam direction for the non-relay STA.

At operation 1930, the relay STA determines which of the second plurality of beam directions is considered to be the best relay STA beam direction for the non-relay STA based on the second indication included in one of the third plurality of beam-sweeping frames.

At operation 1935, the relay STA selects one of the third plurality of beam directions that is associated with a highest received power level at the relay STA to be a best non-relay STA beam direction.

At operation 1940, the relay STA wirelessly transmits a first BBF frame to the non-relay STA in the best relay STA beam direction for the non-relay STA, wherein the first BBF frame includes a third indication of the best non-relay STA beam direction.

At operation 1945, the relay STA wirelessly receives a first BBF ACK frame that acknowledges the first BBF frame from the non-relay STA.

At operation 1950, the relay STA wirelessly receives a second BBF frame from the AP, wherein the second BBF frame includes a fourth indication of which of the second plurality of beam directions is considered by the AP to be a best relay STA beam direction facing the AP.

At operation 1955, the relay STA determines which of the second plurality of beam directions is considered to be the best relay STA beam direction based on the fourth indication included in the BBF frame.

At operation 1960, the relay STA wirelessly transmits a second BBF ACK frame that acknowledges the second BBF frame to the AP in the best relay STA beam direction facing the AP.

In an embodiment, the relay STA wirelessly receives a data frame that includes data intended for the non-relay STA from the AP, wirelessly transmits a relay data frame that includes the data intended for the non-relay STA to the non-relay STA in the best relay STA beam direction facing the non-relay STA, wirelessly receives an ACK frame that acknowledges the relay data frame from the non-relay STA, and wirelessly transmits a relay ACK frame that acknowledges the data frame to the AP in the best relay STA beam direction facing the AP.

In an embodiment, the relay STA wirelessly receives a first relay trigger frame from the AP, wirelessly transmits a second relay trigger frame to the non-relay STA in the best relay STA beam direction facing the non-relay STA, wirelessly receives a data frame that includes data intended for the AP from the non-relay STA, wirelessly transmits a relay data frame that includes the data intended for the AP to the AP in the best relay STA beam direction facing the AP, wirelessly receives an ACK frame that acknowledges the relay data frame from the AP, and wirelessly transmits a relay ACK frame that acknowledges the data frame to the non-relay STA in the best relay STA beam direction facing the non-relay STA.

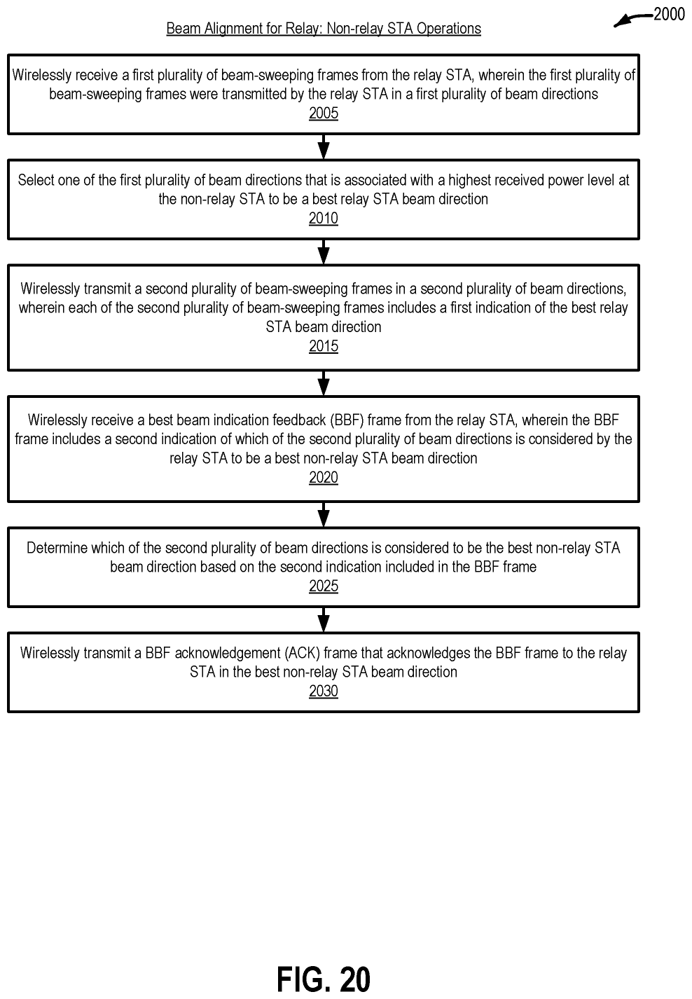

Turning now to FIG. 20, a method 2000 performed by a non-relay STA will be described for performing beam alignment with a relay STA that is to relay frames between an AP and the non-relay STA, in accordance with an example embodiment. The non-relay STA may be implemented by a wireless device 104.

At operation 2005, the non-relay STA wirelessly receives a first plurality of beam-sweeping frames from the relay STA, wherein the first plurality of beam-sweeping frames were transmitted by the relay STA in a first plurality of beam directions.

At operation 2010, the non-relay STA selects one of the first plurality of beam directions that is associated with a highest received power level at the non-relay STA to be a best relay STA beam direction.

At operation 2015, the non-relay STA wirelessly transmits a second plurality of beam-sweeping frames in a second plurality of beam directions, wherein each of the second plurality of beam-sweeping frames includes a first indication of the best relay STA beam direction. In an embodiment, the AP is configured to operate in both a below 7 Gigahertz channel and a mmWave channel, wherein the second plurality of beam-sweeping frames is wirelessly transmitted in the mmWave channel.

At operation 2020, the non-relay STA wirelessly receives a BBF frame from the relay STA, wherein the BBF frame includes a second indication of which of the second plurality of beam directions is considered by the relay STA to be a best non-relay STA beam direction.

At operation 2025, the non-relay STA determines which of the second plurality of beam directions is considered to be the best non-relay STA beam direction based on the second indication included in the BBF frame.

At operation 2030, the non-relay STA wirelessly transmits a BBF ACK frame that acknowledges the BBF frame to the relay STA in the best non-relay STA beam direction.

In an embodiment, the non-relay STA wirelessly receives a relay data frame from the relay STA, wherein the relay data frame includes data generated by the AP. The non-relay STA may then wirelessly transmit an ACK frame that acknowledges the relay data frame to the relay STA in the best non-relay STA beam direction.

In an embodiment, the non-relay STA wirelessly receives a relay trigger frame from the relay STA. The non-relay STA may then wirelessly transmit a data frame that includes data intended for the AP to the relay STA in the best non-relay STA beam direction and wirelessly receive a relay ACK frame that acknowledges the data frame from the relay STA.

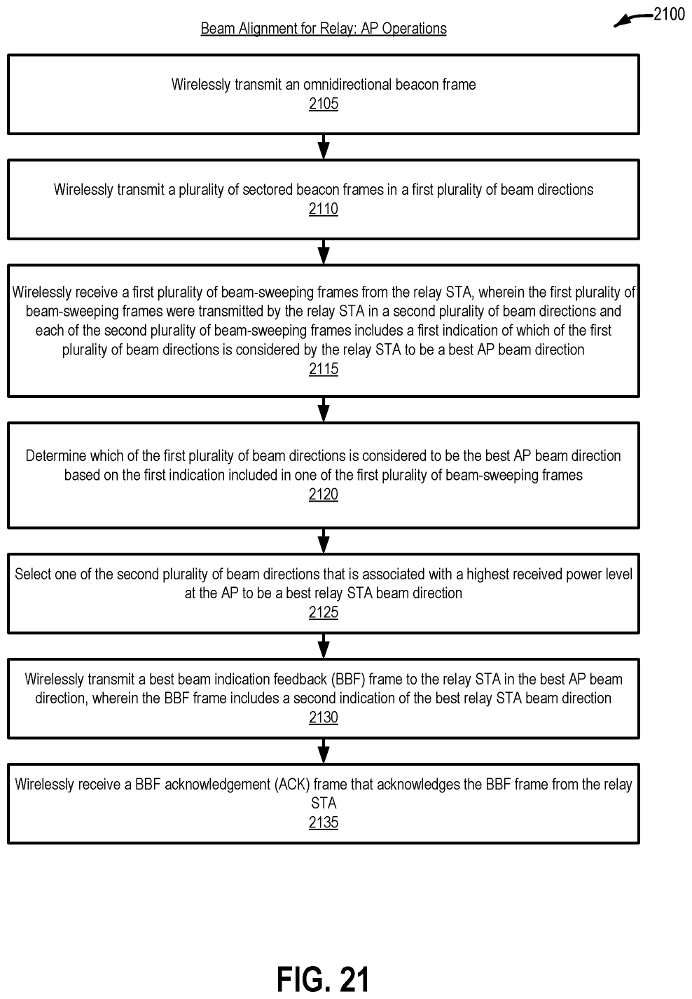

Turning now to FIG. 21, a method 2100 performed by an AP will be described for performing beam alignment (based on sectored beacons) with a relay STA that is to relay frames between the AP and a non-relay STA, in accordance with an example embodiment. The AP may be implemented by a wireless device 104.

At operation 2105, the AP wirelessly transmits an omnidirectional beacon frame.

At operation 2110, the AP wirelessly transmits a plurality of sectored beacon frames in a first plurality of beam directions.

At operation 2115, the AP wirelessly receives a first plurality of beam-sweeping frames from the relay STA, wherein the first plurality of beam-sweeping frames were transmitted by the relay STA in a second plurality of beam directions and each of the second plurality of beam-sweeping frames includes a first indication of which of the first plurality of beam directions is considered by the relay STA to be a best AP beam direction.

At operation 2120, the AP determines which of the first plurality of beam directions is considered to be the best AP beam direction based on the first indication included in one of the first plurality of beam-sweeping frames.

At operation 2125, the AP selects one of the second plurality of beam directions that is associated with a highest received power level at the AP to be a best relay STA beam direction.

At operation 2130, the AP wirelessly transmits a BBF frame to the relay STA in the best AP beam direction, wherein the BBF frame includes a second indication of the best relay STA beam direction.

At operation 2135, the AP wirelessly receives a BBF ACK frame that acknowledges the BBF frame from the relay STA.

In an embodiment, the AP operates in a mmWave channel (e.g., the AP transmits the aforementioned frames using a mmWave channel).

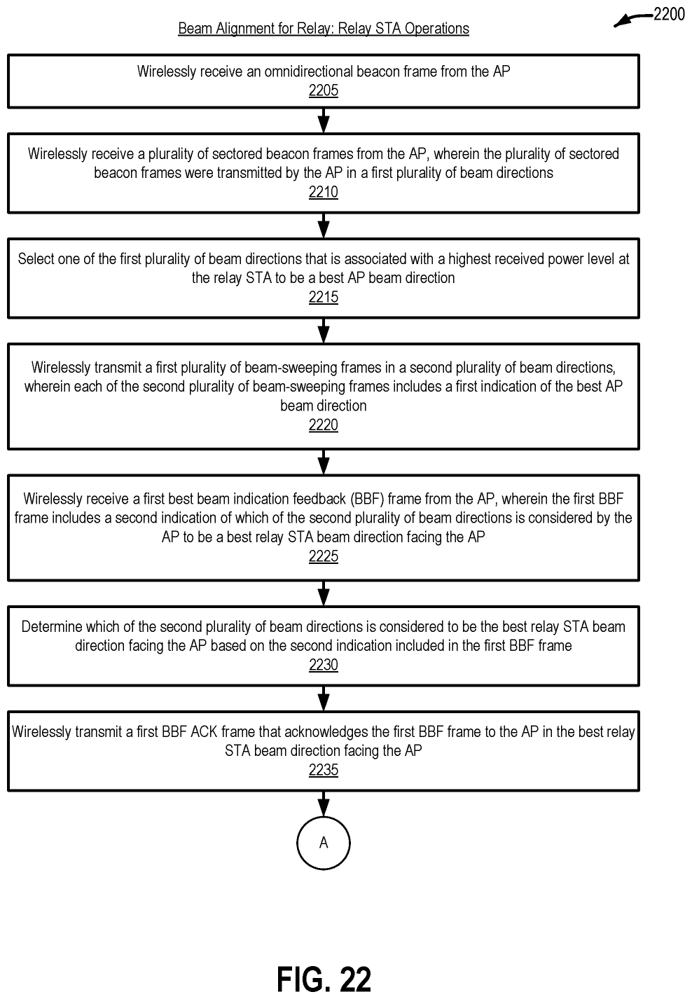

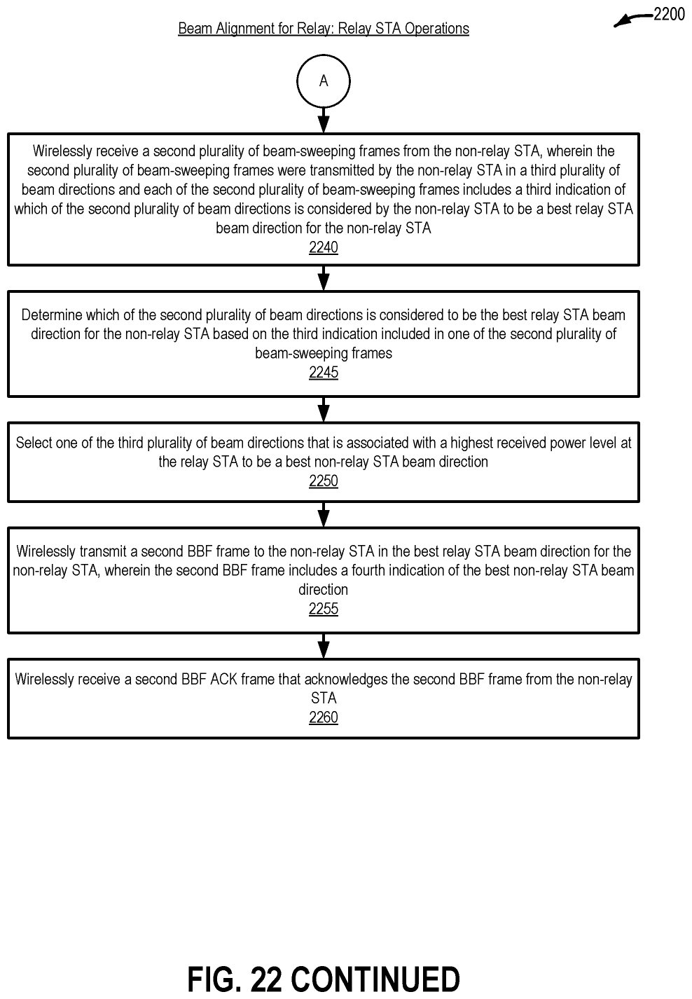

Turning now to FIG. 22, a method 2200 performed by a relay STA will be described for performing beam alignment (based on sectored beacons) with an AP and a non-relay STA to allow the relay STA to relay frames between the AP and the non-relay STA, in accordance with an example embodiment. The relay STA may be implemented by a wireless device 104.

At operation 2205, the relay STA wirelessly receives an omnidirectional beacon frame from the AP.

At operation 2210, the relay STA wirelessly receives a plurality of sectored beacon frames from the AP, wherein the plurality of sectored beacon frames were transmitted by the AP in a first plurality of beam directions.

At operation 2215, the relay STA selects one of the first plurality of beam directions that is associated with a highest received power level at the relay STA to be a best AP beam direction.

At operation 2220, the relay STA wirelessly transmits a first plurality of beam-sweeping frames in a second plurality of beam directions, wherein each of the second plurality of beam-sweeping frames includes a first indication of the best AP beam direction.

At operation 2225, the relay STA wirelessly receives a first BBF frame from the AP, wherein the first BBF frame includes a second indication of which of the second plurality of beam directions is considered by the AP to be a best relay STA beam direction facing the AP.

At operation 2230, the relay STA determines which of the second plurality of beam directions is considered to be the best relay STA beam direction facing the AP based on the second indication included in the first BBF frame.

At operation 2235, the relay STA wirelessly transmits a first BBF ACK frame that acknowledges the first BBF frame to the AP in the best relay STA beam direction facing the AP.

At operation 2240, the relay STA wirelessly receives a second plurality of beam-sweeping frames from the non-relay STA, wherein the second plurality of beam-sweeping frames were transmitted by the non-relay STA in a third plurality of beam directions and each of the second plurality of beam-sweeping frames includes a third indication of which of the second plurality of beam directions is considered by the non-relay STA to be a best relay STA beam direction for the non-relay STA.

At operation 2245, the relay STA determines which of the second plurality of beam directions is considered to be the best relay STA beam direction for the non-relay STA based on the third indication included in one of the second plurality of beam-sweeping frames.

At operation 2250, the relay STA selects one of the third plurality of beam directions that is associated with a highest received power level at the relay STA to be a best non-relay STA beam direction.

At operation 2255, the relay STA wirelessly transmits a second BBF frame to the non-relay STA in the best relay STA beam direction for the non-relay STA, wherein the second BBF frame includes a fourth indication of the best non-relay STA beam direction.

At operation 2260, the relay STA wirelessly receives a second BBF ACK frame that acknowledges the second BBF frame from the non-relay STA.

In an embodiment, the relay STA operates in a mm Wave channel (e.g., the relay STA transmits the aforementioned frames using a mmWave channel).

It is noted that the non-relay STA may perform operations that are similar to the operations shown in FIG. 20, and thus are not described in additional detail herein for sake of brevity.

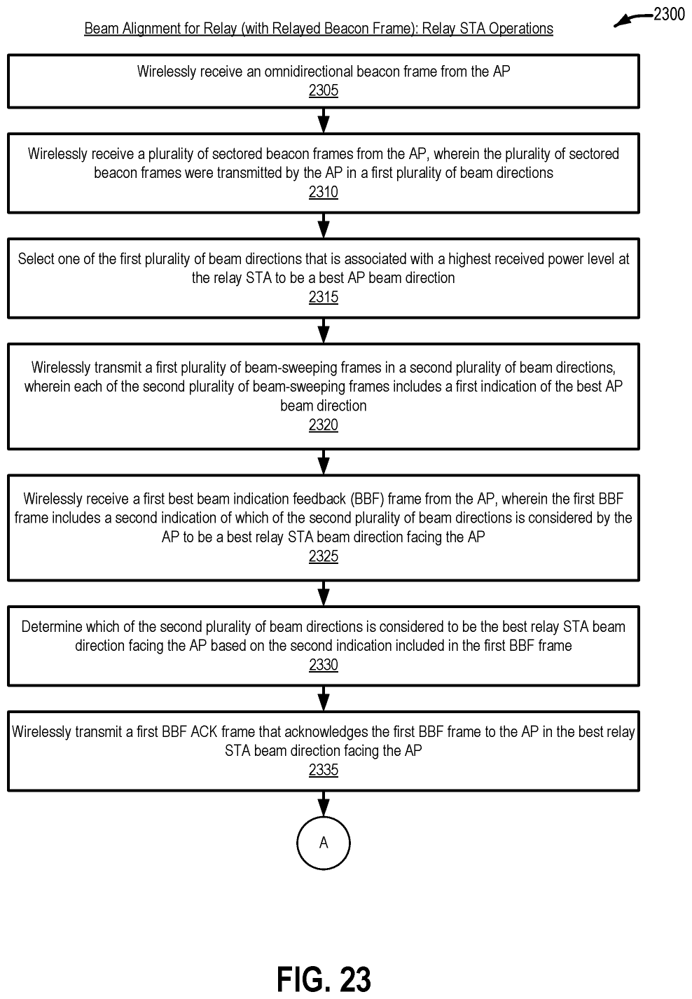

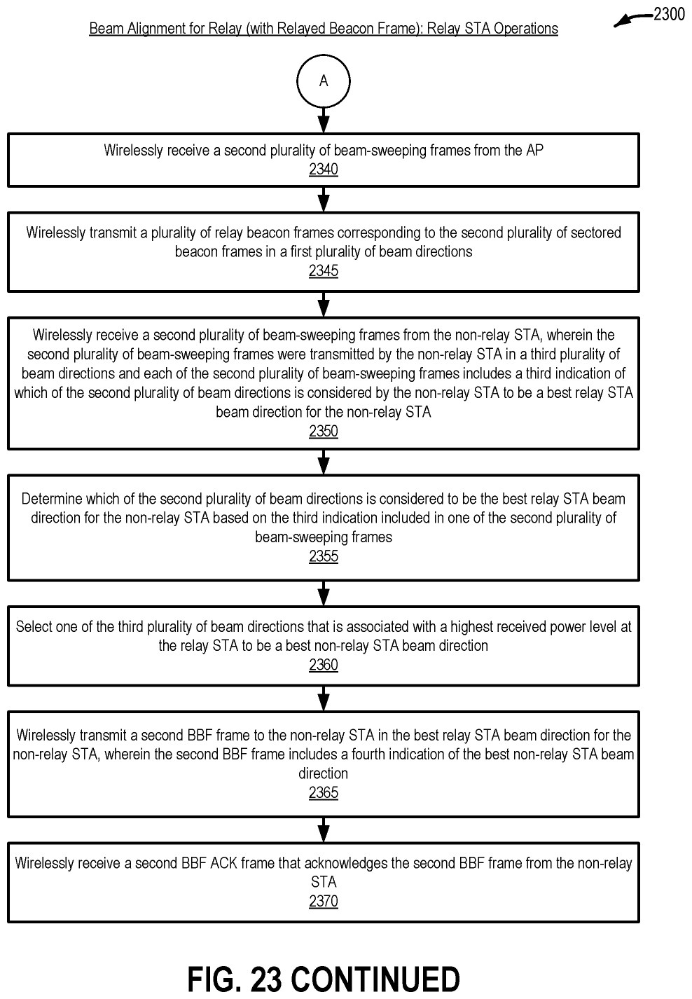

Turning now to FIG. 23, a method 2300 performed by a relay STA will be described for performing beam alignment (based on relayed beacons) with an AP and a non-relay STA to allow the relay STA to relay frames between the AP and the non-relay STA, in accordance with an example embodiment. The relay STA may be implemented by a wireless device 104.

At operation 2305, the relay STA wirelessly receives an omnidirectional beacon frame from the AP.

At operation 2310, the relay STA wirelessly receive a plurality of sectored beacon frames from the AP, wherein the plurality of sectored beacon frames were transmitted by the AP in a first plurality of beam directions.

At operation 2315, the relay STA selects one of the first plurality of beam directions that is associated with a highest received power level at the relay STA to be a best AP beam direction.

At operation 2320, the relay STA wirelessly transmits a first plurality of beam-sweeping frames in a second plurality of beam directions, wherein each of the second plurality of beam-sweeping frames includes a first indication of the best AP beam direction.

At operation 2325, the relay STA wirelessly receives a first BBF frame from the AP, wherein the first BBF frame includes a second indication of which of the second plurality of beam directions is considered by the AP to be a best relay STA beam direction facing the AP.

At operation 2330, the relay STA determines which of the second plurality of beam directions is considered to be the best relay STA beam direction facing the AP based on the second indication included in the first BBF frame.

At operation 2335, the relay STA wirelessly transmits a first BBF ACK frame that acknowledges the first BBF frame to the AP in the best relay STA beam direction facing the AP.

At operation 2340, the relay STA wirelessly receives a second plurality of beam-sweeping frames from the AP.

At operation 2345, the relay STA wirelessly transmits a plurality of relay beacon frames corresponding to the second plurality of sectored beacon frames in a first plurality of beam directions.

At operation 2350, the relay STA wirelessly receives a second plurality of beam-sweeping frames from the non-relay STA, wherein the second plurality of beam-sweeping frames were transmitted by the non-relay STA in a third plurality of beam directions and each of the second plurality of beam-sweeping frames includes a third indication of which of the second plurality of beam directions is considered by the non-relay STA to be a best relay STA beam direction for the non-relay STA.

At operation 2355, the relay STA determines which of the second plurality of beam directions is considered to be the best relay STA beam direction for the non-relay STA based on the third indication included in one of the second plurality of beam-sweeping frames.

At operation 2360, the relay STA selects one of the third plurality of beam directions that is associated with a highest received power level at the relay STA to be a best non-relay STA beam direction.

At operation 2365, the relay STA wirelessly transmit a second BBF frame to the non-relay STA in the best relay STA beam direction for the non-relay STA, wherein the second BBF frame includes a fourth indication of the best non-relay STA beam direction.

At operation 2370, the relay STA wirelessly receives a second BBF ACK frame that acknowledges the second BBF frame from the non-relay STA.

In an embodiment, the relay STA operates in a mmWave channel (e.g., the relay STA transmits the aforementioned frames using a mmWave channel).

It is noted that the AP may perform operations that are similar to the operations shown in FIG. 21, and thus are not described in additional detail herein for sake of brevity.

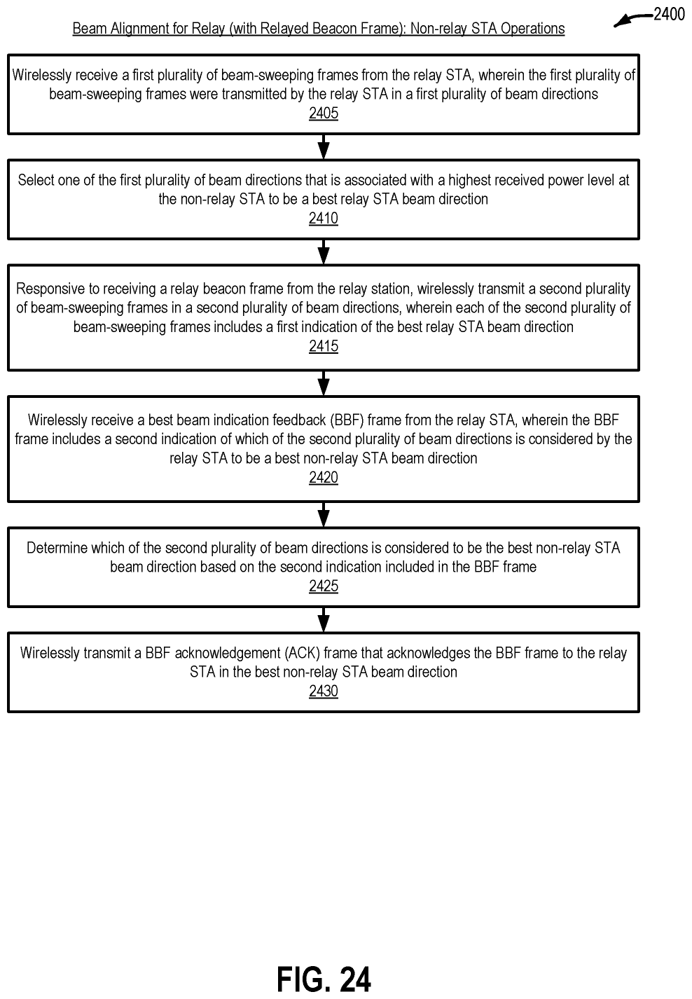

Turning now to FIG. 24, a method 2400 performed by a non-relay STA will be described for performing beam alignment (based on relayed beacons) with a relay STA that is to relay frames between an AP and the non-relay STA, in accordance with an example embodiment. The non-relay STA may be implemented by a wireless device 104.

At operation 2405, the non-relay STA wirelessly receives a first plurality of beam-sweeping frames from the relay STA, wherein the first plurality of beam-sweeping frames were transmitted by the relay STA in a first plurality of beam directions.

At operation 2410, the non-relay STA selects one of the first plurality of beam directions that is associated with a highest received power level at the non-relay STA to be a best relay STA beam direction.

At operation 2415, responsive to receiving a relay beacon frame from the relay station, the non-relay STA wirelessly transmits a second plurality of beam-sweeping frames in a second plurality of beam directions, wherein each of the second plurality of beam-sweeping frames includes a first indication of the best relay STA beam direction.

At operation 2420, the non-relay STA wirelessly receives a BBF frame from the relay STA, wherein the BBF frame includes a second indication of which of the second plurality of beam directions is considered by the relay STA to be a best non-relay STA beam direction.

At operation 2425, the non-relay STA determines which of the second plurality of beam directions is considered to be the best non-relay STA beam direction based on the second indication included in the BBF frame.

At operation 2430, the non-relay STA wirelessly transmits a BBF ACK frame that acknowledges the BBF frame to the relay STA in the best non-relay STA beam direction.

In an embodiment, the non-relay STA operates in a mmWave channel (e.g., the non-relay STA transmits the aforementioned frames using a mmWave channel).

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method performed by a wireless device functioning as a transmitter station (STA) in a wireless network to perform beam alignment with a receiver STA, the method comprising:
wirelessly transmitting a first plurality of beam-sweeping frames in a first plurality of beam directions;
wirelessly receiving a second plurality of beam-sweeping frames from the receiver STA, wherein the second plurality of beam-sweeping frames were transmitted by the receiver STA in a second plurality of beam directions and each of the second plurality of beam-sweeping frames includes a first indication of which of the first plurality of beam directions is considered by the receiver STA to be a best transmitter beam direction;
determining which of the first plurality of beam directions is considered to be the best transmitter beam direction based on the first indication included in one of the second plurality of beam-sweeping frames;
selecting one of the second plurality of beam directions that is associated with a highest received power level at the transmitter STA to be a best receiver beam direction;
wirelessly transmitting a best beam indication feedback (BBF) frame to the receiver STA in the best transmitter beam direction, wherein the BBF frame includes a second indication of the best receiver beam direction; and
wirelessly receiving a BBF acknowledgement (ACK) frame that acknowledges the BBF frame from the receiver STA.

2. The method of claim 1, further comprising:
wirelessly transmitting a data frame to the receiver STA in the best transmitter beam direction.

3. The method of claim 1, wherein the transmitter STA is an access point (AP) and the receiver STA is a non-AP STA.

4. A method performed by a wireless device functioning as a receiver station (STA) in a wireless network to perform beam alignment with a transmitter STA, the method comprising:
wirelessly receiving a first plurality of beam-sweeping frames from the transmitter STA, wherein the first plurality of beam-sweeping frames were transmitted by the transmitter STA in a first plurality of beam directions;
selecting one of the first plurality of beam directions that is associated with a highest received power level at the receiver STA to be a best transmitter beam direction;
wirelessly transmitting a second plurality of beam-sweeping frames in a second plurality of beam directions, wherein each of the second plurality of beam-sweeping frames includes a first indication of the best transmitter beam direction;
wirelessly receiving a best beam indication feedback (BBF) frame from the transmitter STA, wherein the BBF frame includes a second indication of which of the second plurality of beam directions is considered by the transmitter STA to be a best receiver beam direction;
determining which of the second plurality of beam directions is considered to be the best receiver beam direction based on the second indication included in the BBF frame; and
wirelessly transmitting a BBF acknowledgement (ACK) frame that acknowledges the BBF frame to the transmitter STA in the best receiver beam direction.

5. The method of claim 4, further comprising:
wirelessly receiving a data frame from the transmitter STA; and
responsive to receiving the data frame, wirelessly transmitting an acknowledgement (ACK) frame to the transmitter STA in the best receiver beam direction.

6. A method performed by a wireless device functioning as an access point (AP) in a wireless network to perform beam alignment with a relay station (STA) that is to relay data frames between the AP and a non-relay STA, the method comprising:
wirelessly transmitting a beam-sweeping announcement (BSA) frame;
following transmission of the BSA frame, wirelessly transmitting a first plurality of beam-sweeping frames in a first plurality of beam directions;
wirelessly receiving a second plurality of beam-sweeping frames from the relay STA, wherein the second plurality of beam-sweeping frames were transmitted by the relay STA in a second plurality of beam directions and each of the second plurality of beam-sweeping frames includes a first indication of which of the first plurality of beam directions is considered by the relay STA to be a best AP beam direction;
determining which of the first plurality of beam directions is considered to be the best AP beam direction based on the first indication included in one of the second plurality of beam-sweeping frames;
selecting one of the second plurality of beam directions that is associated with a highest received power level at the AP to be a best relay STA beam direction;
wirelessly transmitting a best beam indication feedback (BBF) frame to the relay STA in the best AP beam direction, wherein the BBF frame includes a second indication of the best relay STA beam direction; and
wirelessly receiving a BBF acknowledgement (ACK) frame that acknowledges the BBF frame from the relay STA.

7. The method of claim 6, further comprising:
wirelessly transmitting a data frame that includes data intended for the non-relay STA to the relay STA in the best AP beam direction; and
wirelessly receiving a relay ACK frame that acknowledges the data frame from the relay STA.

8. The method of claim 6, further comprising:
wirelessly transmitting a relay trigger frame to the relay STA in the best AP beam direction; and
wirelessly receiving a relay data frame from the relay STA, wherein the relay data frame includes data intended for the AP that was generated by the non-relay STA.

9. The method of claim 6, wherein the BSA frame includes an identifier of the relay STA and an identifier of the non-relay STA.

10. The method of claim 9, wherein the BSA frame further includes an indication of number of beam-sweeping frames that are to be included in the first plurality of beam-sweeping frames and information regarding a transmission scheme that is to be used to transmit the first plurality of beam-sweeping frames.

11. The method of claim 6, wherein the first plurality of beam-sweeping frames is transmitted sequentially.

12. The method of claim 6, wherein the first plurality of beam-sweeping frames is transmitted simultaneously in different subchannels.

13. The method of claim 6, wherein the BSA frame is wirelessly transmitted in a below 7 Gigahertz channel and the first plurality of beam-sweeping frames is wirelessly transmitted in a millimeter wave channel.

14. A method performed by a wireless device functioning as a relay station (STA) in a wireless network to perform beam alignment with an access point (AP) and a non-relay STA to allow the relay STA to relay data frames between the AP and the non-relay STA, the method comprising:
wirelessly receiving a beam-sweeping announcement (BSA) frame from the AP;
wirelessly receiving a first plurality of beam-sweeping frames from the AP, wherein the first plurality of beam-sweeping frames were transmitted by the AP in a first plurality of beam directions;
selecting one of the first plurality of beam directions that is associated with a highest received power level at the relay STA to be a best AP beam direction;
wirelessly transmitting a second plurality of beam-sweeping frames in a second plurality of beam directions, wherein each of the second plurality of beam-sweeping frames includes a first indication of the best AP beam direction;
wirelessly receiving a third plurality of beam-sweeping frames from the non-relay STA, wherein the third plurality of beam-sweeping frames were transmitted by the non-relay STA in a third plurality of beam directions and each of the third plurality of beam-sweeping frames includes a second indication of which of the second plurality of beam directions is considered by the non-relay STA to be a best relay STA beam direction facing the non-relay STA;
determining which of the second plurality of beam directions is considered to be the best relay STA beam direction facing the non-relay STA based on the second indication included in one of the third plurality of beam-sweeping frames;
selecting one of the third plurality of beam directions that is associated with a highest received power level at the relay STA to be a best non-relay STA beam direction;
wirelessly transmitting a first best beam indication feedback (BBF) frame to the non-relay STA in the best relay STA beam direction facing the non-relay STA, wherein the first BBF frame includes a third indication of the best non-relay STA beam direction;
wirelessly receiving a first BBF acknowledgement (ACK) frame that acknowledges the first BBF frame from the non-relay STA;
wirelessly receiving a second BBF frame from the AP, wherein the second BBF frame includes a fourth indication of which of the second plurality of beam directions is considered by the AP to be a best relay STA beam direction facing the AP;
determining which of the second plurality of beam directions is considered to be the best relay STA beam direction based on the fourth indication included in the BBF frame; and
wirelessly transmitting a second BBF ACK frame that acknowledges the second BBF frame to the AP in the best relay STA beam direction facing the AP.

15. The method of claim 14, further comprising:
wirelessly receiving a data frame that includes data intended for the non-relay STA from the AP;
wirelessly transmitting a relay data frame that includes the data intended for the non-relay STA to the non-relay STA in the best relay STA beam direction facing the non-relay STA;
wirelessly receiving an ACK frame that acknowledges the relay data frame from the non-relay STA; and
wirelessly transmitting a relay ACK frame that acknowledges the data frame to the AP in the best relay STA beam direction facing the AP.

16. The method of claim 14, further comprising:
wirelessly receiving a first relay trigger frame from the AP;
wirelessly transmitting a second relay trigger frame to the non-relay STA in the best relay STA beam direction facing the non-relay STA;
wirelessly receiving a data frame that includes data intended for the AP from the non-relay STA;
wirelessly transmitting a relay data frame that includes the data intended for the AP to the AP in the best relay STA beam direction facing the AP;
wirelessly receiving an ACK frame that acknowledges the relay data frame from the AP; and
wirelessly transmitting a relay ACK frame that acknowledges the data frame to the non-relay STA in the best relay STA beam direction facing the non-relay STA.

17. The method of claim 14, wherein the BSA frame is wirelessly transmitted by the AP in a below 7 Gigahertz channel and the second plurality of beam-sweeping frames is wirelessly transmitted in a millimeter wave channel.

18. A method performed by a wireless device functioning as a non-relay station (STA) in a wireless network to perform beam alignment with a relay STA that is to relay data frames between an access point (AP) and the non-relay STA, the method comprising:
wirelessly receiving a first plurality of beam-sweeping frames from the relay STA, wherein the first plurality of beam-sweeping frames were transmitted by the relay STA in a first plurality of beam directions;
selecting one of the first plurality of beam directions that is associated with a highest received power level at the non-relay STA to be a best relay STA beam direction;
wirelessly transmitting a second plurality of beam-sweeping frames in a second plurality of beam directions, wherein each of the second plurality of beam-sweeping frames includes a first indication of the best relay STA beam direction;
wirelessly receiving a best beam indication feedback (BBF) frame from the relay STA, wherein the BBF frame includes a second indication of which of the second plurality of beam directions is considered by the relay STA to be a best non-relay STA beam direction;
determining which of the second plurality of beam directions is considered to be the best non-relay STA beam direction based on the second indication included in the BBF frame; and
wirelessly transmitting a BBF acknowledgement (ACK) frame that acknowledges the BBF frame to the relay STA in the best non-relay STA beam direction.

19. The method of claim 18, further comprising:
wirelessly receiving a relay data frame from the relay STA, wherein the relay data frame includes data generated by the AP; and
wirelessly transmitting an ACK frame that acknowledges the relay data frame to the relay STA in the best non-relay STA beam direction.

20. The method of claim 18, further comprising:
wirelessly receiving a relay trigger frame from the relay STA;
wirelessly transmitting a data frame that includes data intended for the AP to the relay STA in the best non-relay STA beam direction; and
wirelessly receiving a relay ACK frame that acknowledges the data frame from the relay STA.

21. The method of claim 18, wherein the AP is configured to operate in both a below 7 Gigahertz channel and a millimeter wave channel, wherein the second plurality of beam-sweeping frames is wirelessly transmitted in the millimeter wave channel.

22.-25. (canceled)
